(19) United States
(12) Patent Application Publication
(10) Pub. No.: US 2016/0195828 A1
(43) Pub. Date: Jul. 7, 2016

(54) TONER, TONER STORED UNIT, AND IMAGE FORMING APPARATUS

(71) Applicants: Ayumi SATOH, Shizuoka (JP); Naohiro WATANABE, Shizuoka (JP); Masana SHIBA, Shizuoka (JP); Takahiro HONDA, Shizuoka (JP); Ryota INOUE, Shizuoka (JP); Daisuke INOUE, Shizuoka (JP); Shingo SAKASHITA, Shizuoka (JP); Rintaro TAKAHASHI, Kanagawa (JP)

(72) Inventors: Ayumi SATOH, Shizuoka (JP); Naohiro WATANABE, Shizuoka (JP); Masana SHIBA, Shizuoka (JP); Takahiro HONDA, Shizuoka (JP); Ryota INOUE, Shizuoka (JP); Daisuke INOUE, Shizuoka (JP); Shingo SAKASHITA, Shizuoka (JP); Rintaro TAKAHASHI, Kanagawa (JP)

(21) Appl. No.: 14/986,947

(22) Filed: Jan. 4, 2016

(30) Foreign Application Priority Data
Jan. 5, 2015 (JP) 2015-000387
Nov. 30, 2015 (JP) 2015-232998

(51) Int. Cl. G03G 9/00

(52) U.S. Cl. CPC G03G 9/08755; G03G 9/08711

(57) ABSTRACT

Toner including binder resin; wherein the toner, as measured by differential scanning calorimetry (DSC), has glass transition temperature in range of 40° C. through 70° C. at first temperature rising and has no glass transition temperature in range of X° C. through X−20° C. at second temperature rising where X° C. denotes the glass transition temperature at the first temperature rising, the toner has difference of 30 or less between maximum value and minimum value among peak intensities in range of Molecular weight M±300 where Molecular weight M is molecular weight selected from range of 300 through 5,000 in molecular weight distribution of THF-soluble components in the toner as measured by GPC, and the peak intensities are defined as relative values assuming the maximum peak value in molecular weights of 20,000 or less is 100, in molecular weight distribution curve taking intensity as vertical axis and molecular weight as horizontal axis as measured by GPC.

### CROSS-REFERENCE TO RELATED APPLICATIONS

The present application claims priority under 35 U.S.C. §119 to Japanese Patent Application No. 2015-000387, filed Jan. 5, 2015 and Japanese Patent Application No. 2015-232998, filed Nov. 30, 2015. The contents of which are incorporated herein by reference in their entirety.

### BACKGROUND OF THE INVENTION

1. Field of the Invention

The present disclosure relates to toners, toner stored units, and image forming apparatuses.

2. Description of the Related Art

Recently, in the field of electrophotographic image forming technology, there is a need for a technologically advanced image forming apparatus. Specifically, there is a need for stably providing high quality images without any image errors through the use of a functional toner for developing an electrostatic image, as well as for saving energy by fixing a toner on a medium at a lower temperature (low temperature fixing property).

To meet the above described needs, Japanese Patent (JP-B) No. 4984913 discloses a toner containing, as a binder resin, both of a crystalline resin and a noncrystalline resin. Specifically, the toner contains, as the binder resin, both of a crystalline polyester resin and a noncrystalline polyester resin. This imparts sharp meltability to the toner and inhibit surfaces of toner particles from changing due to mechanical stress over time, to thereby improve charging stability.

However, it has been found that, in the above toner, an oligomer component contained in the binder resin is compatibilized with a component contained in the crystalline resin to serve as a plasticizer, leading to deterioration of storability of the toner.

Japanese Patent Application Laid-Open (JP-A) No. 2007-249061 discloses that a plasticizer contained in a toner is compatibilized with the binder resin due to heat applied during fixing, to thereby achieve fixing at a low temperature.

However, also in the above toner in the same manner as in JP-B No. 4984913, the plasticizer starts to compatibilize with the binder resin due to heat, leading to deterioration of the storability.

As described above, a toner containing a crystalline polyester exhibits the charging stability and excellent low temperature fixing property, but is difficult to ensure the storability. Therefore, there is a need for a toner having all of the charging stability, the low temperature fixing property, and the storability at a high level.

### SUMMARY OF THE INVENTION

The present invention has been made in view of the foregoing problems, and aims to provide a toner having improved low temperature fixing property, charging stability, and storage stability.

To solve the above existing problems, the present invention provides a toner including a binder resin. As measured by differential scanning calorimetry (DSC), the toner has a glass transition temperature in a range of from 40° C. through 70° C. at the first temperature rising and has no glass transition temperature in a range of from X° C. through X−20° C. at the second temperature rising where X° C. denotes the glass transition temperature at the first temperature rising. Additionally, the toner has a difference of 30 or less between the maximum value and the minimum value among peak intensities defined below in a range of Molecular weight M±300 where Molecular weight M is a molecular weight selected from a range of from 300 through 5,000 in a molecular weight distribution of tetrahydrofuran (THF)-soluble components in the toner as measured by GPC. The peak intensities are defined as relative values assuming the maximum peak value in molecular weights of 20,000 or less is 100, in a molecular weight distribution curve taking an intensity as a vertical axis and a molecular weight as a horizontal axis as measured by GPC.

According to the present invention, a toner having improved low temperature fixing property, charging stability, and storage stability can be provided.

### BRIEF DESCRIPTION OF THE DRAWINGS

FIG. 1A is a schematic graph illustrating one exemplary molecular weight distribution of THF-soluble components in a toner as measured by GPC;

FIG. 1B is a schematic graph illustrating another exemplary molecular weight distribution of THF-soluble components in a toner as measured by GPC;

FIG. 2 is a schematic diagram illustrating one exemplary image forming apparatus according to the present invention;

FIG. 3 is a schematic diagram illustrating another exemplary image forming apparatus according to the present invention;

FIG. 4 is a schematic diagram illustrating another exemplary image forming apparatus according to the present invention;

FIG. 5 is a schematic diagram illustrating another exemplary image forming apparatus according to the present invention;

FIG. 6 is a schematic explanatory graph illustrating one exemplary GPC measurement result of a toner according to the present invention;

FIG. 7 is a schematic explanatory graph illustrating one exemplary GPC measurement result of a conventional toner;

FIG. 8 is a schematic explanatory graph illustrating another exemplary GPC measurement result of a toner according to the present invention; and

FIG. 9 is a schematic explanatory graph illustrating another exemplary GPC measurement result of a conventional toner.

### DETAILED DESCRIPTION OF THE INVENTION

A toner, a toner stored unit, and an image forming apparatus according to the present invention will now be described referring to figures. Notably, the present invention is not limited to the below described embodiments and can be changed within the scope that those skilled in the art can conceive. For example, other embodiments, addition, modification, or deletion may be made. Any of the aspects is within the scope of the present invention as long as operation and effect of the present invention are realized thereby.

The present invention provides a toner including a binder resin. As measured by differential scanning calorimetry (DSC), the toner has a glass transition temperature (Tg1) in a range of from 40° C. through 70° C. at the first temperature rising and has no glass transition temperature (Tg2) in a range of from X° C. through X−20° C. at the second temperature rising where X° C. denotes the glass transition temperature (Tg1). Additionally, the toner has a difference of 30 or less between the maximum value and the minimum value among peak intensities defined below in a range of Molecular weight M±300 where Molecular weight M is a molecular weight selected from a range of from 300 through 5,000 in a molecular weight distribution of THF-soluble components in the toner as measured by GPC. The peak intensities are defined as relative values assuming the maximum peak value in molecular weights of 20,000 or less is 100, in a molecular weight distribution curve taking an intensity as a vertical axis and a molecular weight as a horizontal axis as measured by GPC.

The details will now be described below.

### (Toner)

For the purpose of imparting sharp meltability and a toner property being advantageous for a low temperature fixing property to a toner of the present invention, the toner has, as measured by DSC, a glass transition temperature in the range of from 40° C. through 70° C. at the first temperature rising and has no glass transition temperature in the range of from X° C. through X−20° C. at the second temperature rising where X° C. denotes the glass transition temperature at the first temperature rising. The glass transition temperature at the first temperature rising of lower than 40° C. deteriorates storage stability and charging stability. The glass transition temperature at the first temperature rising of higher than 70° C. deteriorates the low temperature fixing property.

For the purpose of meeting the condition, the binder resin preferably contains a crystalline resin. In order to achieve the toner having, as measured by DSC, a glass transition temperature in the range of from 40° C. through 70° C. at the first temperature rising and having no glass transition temperature in the range of from X° C. through X−20° C. at the second temperature rising where X° C. denotes the glass transition temperature at the first temperature rising, the binder resin preferably consists of or partially contains a crystalline polyester. The crystalline polyester is not particularly limited and may be appropriately selected depending on the intended purpose, but those described in the section of Crystalline polyester resin are suitably used.

Inclusion of the crystalline polyester in the binder resin can impart the charging stability and the sharp meltability to the toner. Additionally, the present inventors have been found that the heat resistant storability is deteriorated in the case where components having certain molecular weights are detected as peaks in a molecular weight distribution of THF-soluble components in the binder resin as measured by GPC.

The reason why this occurs is not well understood, but is believed as follows. For each peak, components in a certain peak form a domain and are collectively compatibilized with the crystalline polyester to serve as a plasticizer. This greatly deteriorates heat resistance, and thus, storability of the toner.

Therefore, the present inventors have been found that the storability can be ensured by meeting a predetermined condition in the molecular weight distribution of THF-soluble components in the toner as measured by GPC. Thus, the present invention has been completed.

In the present invention, it is important that the toner has the difference of 30 or less between the maximum value and the minimum value among peak intensities in a range of Molecular weight M±300 where Molecular weight M is a molecular weight selected from the range of 300 to 5,000 in a molecular weight distribution of THF-soluble components in the toner as measured by GPC. Thus, the peak components that may serve as the plasticizer for the binder resin can be eliminated to ensure the storability. Notably, the following condition may be referred to as “Condition A”: the toner has a difference of 30 or less between the maximum value and the minimum value among peak intensities in a range of Molecular weight M±300 where Molecular weight M is a molecular weight selected from the range of 300 to 5,000 in a molecular weight distribution of THF-soluble components in a toner as measured by GPC.

Notably, the peak intensities are defined as relative values assuming the maximum peak value in molecular weights of 20,000 or less is 100, in a molecular weight distribution curve taking an intensity as a vertical axis and a molecular weight as a horizontal axis as measured by GPC.

In contrast, in the case where the Condition A is not met, that is, the difference between the maximum value and the minimum value among peak intensities in a range of Molecular weight M±300 is greater than 30, the peak components that may serve as the plasticizer remain in the toner in large quantities to thereby be compatibilized with the binder resin (e.g., the crystalline polyester), leading to deterioration of the storability of the toner.

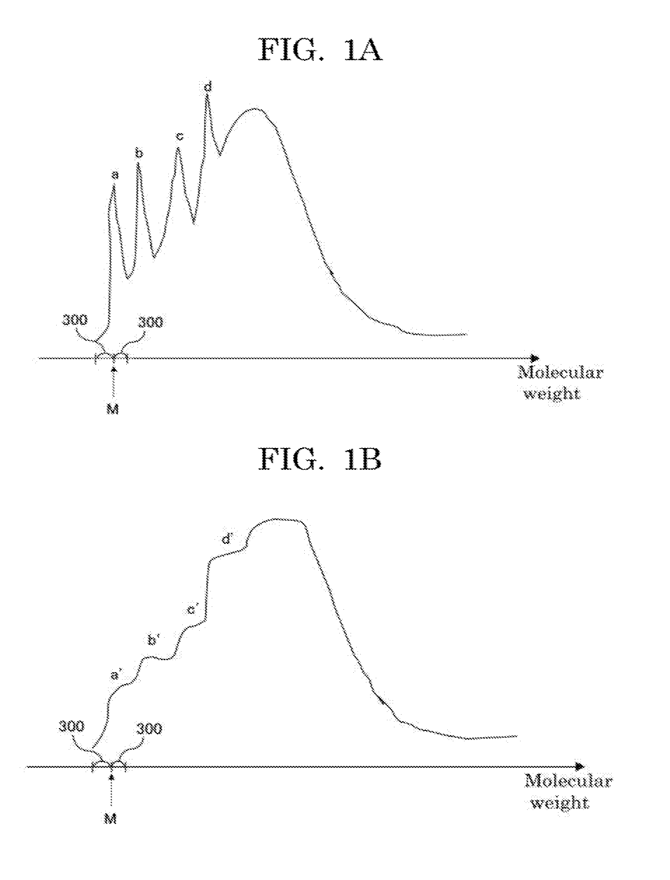

FIGS. 1A and 1B are schematic views illustrating exemplary molecular weight distributions of THF-soluble components in a toner as measured by GPC.

In the present invention, the toner has the difference of 30 or less between the maximum value and the minimum value among peak intensities in the range of Molecular weight M±300 where Molecular weight M is a molecular weight selected from the range of 300 to 5,000.

FIG. 1A represents the case where the Condition A is not met. In FIG. 1A, the Molecular weight M is set adjacent to Peak a, and the difference between the maximum value and the minimum value among peak intensities in the range of the Molecular weight M±300 is increased. Also for other peaks (Peak b, c, and d), it can be seen that the differences are increased.

Meanwhile, FIG. 1B represents the case where the Condition A is met. Peaks a′ to d′ in which the difference between the maximum value and the minimum value is 30 or less are illustrated corresponding to Peaks a to d in FIG. 1A. The Peaks a′ to d′ in FIG. 1B meet the Condition A, so that the difference between the maximum value and the minimum value among peak intensities in the range of the Molecular weight M±300 is 30 or less, but the peaks are present as peaks.

To determine whether the Condition A is met, a plurality of points in the range of the Molecular weight M±300 (that is, the molecular weight distribution width of 600) in molecular weights in the range of 300 to 5,000 is needed to be determined. The number of the points to be determined is not particularly limited. The points may be same as or different from each other.

A method for allowing the Condition A to be met is not particularly limited. For example, in the case where a noncrystalline resin is used as the binder resin, a method in which low molecular weight components in the noncrystalline resin is decreased, a method in which a terminal hydrophilic group in the binder resin is replaced with a lipophilic group, or a method in which a resin synthesis reaction is accelerated may be used. The method in which a terminal hydrophilic group in the binder resin is replaced with a lipophilic group is not particularly limited, but, for example, a method in which a terminal hydroxyl group is replaced with phenoxyacetic acid or benzoic acid may be used. The method in which a resin synthesis reaction is accelerated is not particularly limited, but, for example, a method in which a monomer is removed by increasing the degree of decompression through a reaction at a high temperature for a long period of timer may be used.

In the case of fractionating, through preparative GPC, components having the difference of 30 or less between the maximum value and the minimum value among peak intensities in the range of Molecular weight M±300 where Molecular weight M is a molecular weight selected from a range of from 300 through 5,000, any of the components that have been fractionated preferably contain a material including Monomer A.

The Monomer A is a monomer having a molecular weight of 210 or less and including an acid functional group.

For example, the schematic diagram illustrated in FIG. 1B, for the Peaks a′ to d′ that meet the Condition A and are present as peaks, components in the Peaks a′ to d′ are fractionated, identified, and determined whether the Monomer A is contained.

The material including the Monomer A, that is, a monomer having a molecular weight of 210 or less and including an acid functional group may be a reaction product of a monomer included in the binder resin used for the toner.

Examples of the reaction product of a monomer include a derivative of isophthalic acid, adipic acid, or sebacic acid; and bisphenol A propylene oxide adduct of isophthalic acid, adipic acid, or sebacic acid.

The binder resin containing the material often has to be used for the purpose of decreasing the glass transition temperature and viscoelasticity in terms of achieving excellent low temperature fixing property.

However, the material remaining in the toner is likely to serve as the plasticizer due to its very high compatibility with the crystalline resin, leading to deterioration of the storability of the toner.

Therefore, in the present invention, for the purpose of preventing the material from deteriorating the storability of the toner, it is important to meet the Condition A, that is, the toner has a difference of 30 or less between the maximum value and the minimum value among peak intensities in the range of Molecular weight M±300 where Molecular weight M is a molecular weight selected from a range of from 300 through 5,000. The toner that meets the Condition A and that contains the material including the Monomer A in components fractionated as described above can achieve the excellent low temperature fixing property.

Examples of the Monomer A include an aromatic dicarboxylic acid such as isophthalic acid, terephthalic acid, phthalic acid, and malonic acid; and an aliphatic dicarboxylic acid such as oxalic acid, succinic acid, glutaric acid, adipic acid, and sebacic acid.

Of these, preferable is a dicarboxylic acid selected from the aromatic dicarboxylic acid group consisting of isophthalic acid, terephthalic acid, and phthalic acid; and the aliphatic dicarboxylic acid group consisting of succinic acid, glutaric acid, adipic acid, and sebacic acid.

In this case, more excellent low temperature fixing property, storability, and charging stability can be achieved.

For the purpose of improving the low temperature fixing property, the binder resin preferably includes a polyester resin consisting of at least one selected from the aliphatic diol group consisting of 1,4-butanediol, 1,6-hexanediol, and 1,9-nonanediol; and at least one selected from the aliphatic dicarboxylic acid group consisting of fumaric acid, sebacic acid, and dodecane dicarboxylic acid.

In the case of using polyester, for the purpose of imparting crystallinity to the polyester to thereby compatibilize with the binder resin and imparting the low temperature fixing property and the storage stability at a high level to the toner, the crystalline polyester including the above described components is preferably used.

However, in the case of using the above crystalline polyester, as well the above described binder resin, the above described monomer components contained in the crystalline polyester are likely to serve as the plasticizer to be compatibilized with the crystalline polyester, making it susceptible to a deterioration the storability.

Therefore, in the present invention, for the purpose of preventing the material from deteriorating the storability of the toner, it is important to meet the Condition A, that is, the toner has a difference of 30 or less between the maximum value and the minimum value among peak intensities in the range of Molecular weight M±300 where Molecular weight M is a molecular weight selected from a range of from 300 through 5,000. The toner that meets the Condition A and that contains the crystalline polyester can achieve the excellent low temperature fixing property and storage stability.

In the present invention, the toner can be subjected to DSC measurement using, for example, a differential scanning calorimeter (e.g., DSC-6220R, manufactured by Seiko Instruments Inc.).

Specifically, a sample is heated from room temperature to 150° C. at a temperature rising rate of 10° C./min (first temperature rising); left to stand at 150° C. for 10 min; cooled to room temperature; left to stand at room temperature for 10 min; and then heated again to 150° C. at a temperature rising rate of 10° C./min (second temperature rising). In the resultant DSC curve, the glass transition temperature can be determined from the base line at a temperature equal to or lower than the glass transition temperature and a curved line portion at a height which corresponds to ½ of the distance from the base line at a temperature equal to or lower than the glass transition temperature to the base line at a temperature equal to or higher than the glass transition temperature.

A molecular weight distribution of THF-soluble components in the toner as measured by GPC is determined as follows.

Gel permeation chromatography (GPC) measuring device: GPC-8220GPC (manufactured by Tosoh Corporation)

Column: TSK-GEL SUPER HZ2000, TSK-GEL SUPER HZ2500, and TSK-GEL SUPER HZ3000

Temperature: 40° C.

Solvent: tetrahydrofuran (THF)

Flow rate: 0.35 mL/min

Sample: THF sample solution having a concentration adjusted to 0.15% by mass

Pretreatment of sample: a toner is dissolved in THF (containing a stabilizer, manufactured by Wako Pure Chemical Industries, Ltd.) at 0.15% by mass, followed by filtering through a 0.45 μm filter. The resultant filtrate is used as the sample.

The measurement can be performed by injecting a range of from 10 μL through 200 μL of the THF sample solution. As for the measurement of the sample, a molecular weight of the sample is calculated from the relationship between the number of counts and the logarithmic value of the calibration curve prepared from several monodispersed polystyrene standard samples.

As for the polystyrene standard sample for preparing the calibration curve, for example, TSK standard polystyrenes having molecular weights of 37,200, 6,200, 2,500, and 589 (manufactured by Tosoh Corporation) and standard polystyrenes and toluenes having molecular weights of 28,400, 20,298, 10,900, 4,782, 1,689, and 1,309 (manufactured by SHOWA DENKO K.K.) can be used. As for a detector, a refractive index (RI) detector is used.

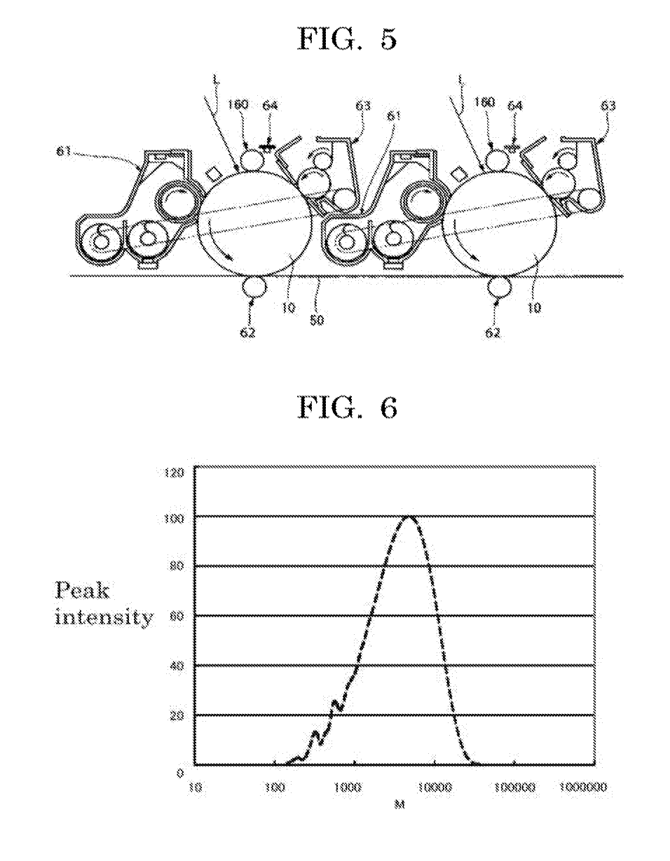

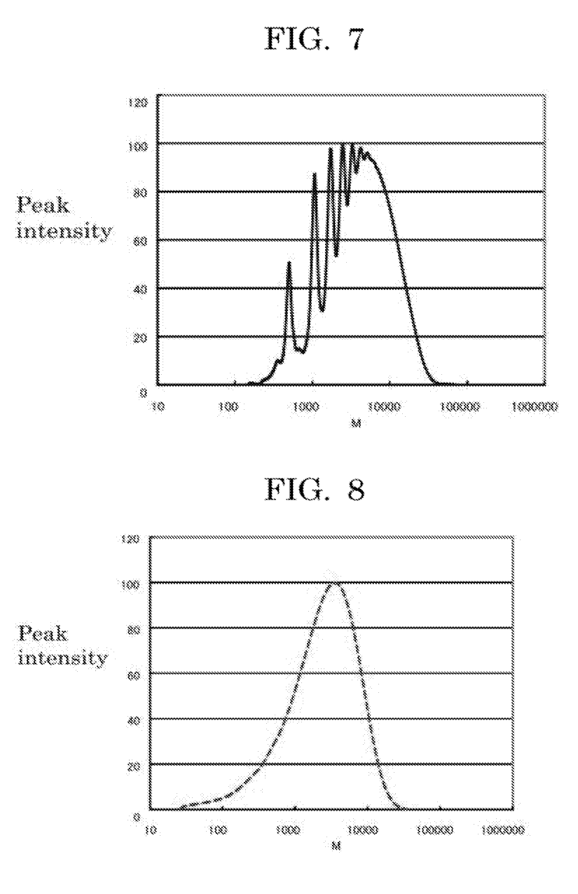

Selection of a column is important in the GPC measurement of THF-soluble components in a toner according to the present invention. The result is presented in FIG. 6 in the case where the above described columns were used to measure “a toner having a difference of 30 or less between the maximum value and the minimum value among peak intensities defined below (the definition is omitted) in a range of Molecular weight M±300 where Molecular weight M is a molecular weight selected from a range of from 300 through 5,000 in a molecular weight distribution of tetrahydrofuran (THF)-soluble components in the toner as measured by GPC” (Toner A). Meanwhile, the result from a conventional toner that is outside the scope of the present invention (Toner B) is presented in FIG. 7.

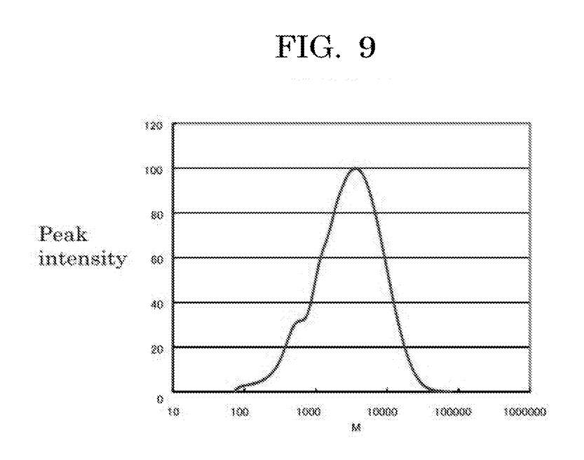

On the other hand, the results are presented in FIGS. 8 and 9 in the case where three “TSK-GEL SUPER HZM-H” columns connected in series were used for the measurement instead of the above described “Column: TSK-GEL SUPER HZ2000, TSK-GEL SUPER HZ2500, and TSK-GEL SUPER HZ300” (manufactured by Tosoh Corporation). FIG. 8 represents the result from Toner A, and FIG. 9 represents the result from Toner B. In this case, difference was not found between the Toner A and the conventional Toner B. Thus, selection of a column is important.

In the present invention, a preparative GPC device is used to fractionate the peak that presents in the range of Molecular weight M±300 and that meets the Condition A. Thereafter, IR, ¹H-NMR, MALDI-MS, or DIMS can be used to structurally analyze and identify a substance contained in the peak.

The preparative GPC can be performed as follows. Firstly, a toner is dissolved into chloroform, followed by fractionating components in the toner based on the molecular weight under the following conditions:

Device: pump LC-6A, fraction collector FRC-10A, and RI detector RID-10A (manufactured by SHIMADZU CORPORATION)

Column: SHODEX K2002×2+SHODEX K2003 (diameter: 20 mm, length: 300 mm)

Mobile phase: chloroform

Flow rate: 2.8 mL/min

Column oven: 45° C.

Other physical properties of the toner will now be described.

### —Weight Average Molecular Weight (Mw) of the Toner—

The weight average molecular weight (Mw) of the toner is preferably a range of from 5,000 through 18,000. The Mw of 5,000 or higher is preferable since toner particles are less likely to aggregate with each other and an abnormal image can be sufficiently prevented from being produced. The Mw of 18,000 or lower is preferable since the toner has better low temperature fixing property, a toner layer on the side of a recording medium (underside) with which a fixing member is not in direct contact in a low temperature range is well melted, and an image is not flaked off.

The weight average molecular weight (Mw) of the toner can be measured by gel permeation chromatography (GPC). Specifically, a column is stabilized in a heat chamber at 40° C. Tetrahydrofuran (THF) serving as a solvent is flowed through the stabilized column at a flow rate of 1 mL/min. Then, a range of from 50 μL through 200 μL of a THF sample solution of the toner adjusted to have a sample concentration of a range of from 0.05% by mass through 0.6% by mass was injected into the column, to thereby measure the weight average molecular weight.

As for the measurement of the molecular weight, a molecular weight of the sample is calculated from the relationship between the number of counts and the logarithmic value of the calibration curve prepared from several monodispersed polystyrene standard samples. As for the polystyrene standard sample for preparing the calibration curve, for example, polystyrene standard samples having molecular weights of 6×10², 2.1×10³, 4×10³, 1.75×10⁴, 5.1×10⁴, 1.1×10⁵, 3.9×10⁵, 8.6×10⁵, 2×10⁶ and 4.48×10⁶ (manufactured by Pressure Chemical Company or Tosoh Corporation) are used. At least 10 polystyrene standard samples are suitably used. As for a detector, a refractive index (RI) detector is used.

A shape and a size of the toner are not particularly limited and may be appropriately selected depending on the intended purpose, but the toner preferably has the following average circularity, the following volume average particle diameter, and the following ratio of the volume average particle diameter to the number average particle diameter (volume average particle diameter/number average particle diameter).

### —Average Circularity of Toner Particles—

The average circularity of the toner particles is a value obtained by dividing a perimeter of a circle that has the same projected area as a shape of the toner particle by a perimeter of an actual particle. The average circularity of the toner particles is preferably a range of from 0.950 through 0.980, more preferably a range of from 0.960 through 0.975. The toner particles having the average circularity of less than 0.95% is preferably 15% or less.

When the average circularity of the toner particles is less than 0.950, transferability to be satisfied and an image having high quality and having no dust may not be obtained. In an image forming system employing blade cleaning, the toner particles having an average circularity of more than 0.980 may cause cleaning failure on a photoconductor and on a transfer belt, and may cause fog on an image, such as background fog that is caused by accumulating the residual toner after transfer. The residual toner after transfer remains on the photoconductor when an untransferred image is formed due to paper feeding failure, for example, in cases where an image having high image area rate such as a photographic image is formed. Alternatively, the toner particles having an average circularity of more than 0.980 may pollute, for example, a charging roller configured to charge a photoconductor in a contact manner, which results in degradation of original charging ability.

The average circularity can be measured by, for example, a flow type particle image analyzer (“FPIA-2100”, product of SYSMEX CORPORATION), and analysis can be performed using an analysis software (FPIA-2100, Data Processing Program for FPIA version 00-10).

Specifically, a 10% by mass surfactant (alkyl benzene sulfonate, NEOGEN SC-A, product of DKS Co. Ltd.) (a range of from 0.1 mL through 0.5 mL) is added to a 100 mL-glass beaker, and each toner (a range of from 0.1 g through 0.5 g) is added thereto. Then, the mixture is stirred by a micro-spatula, followed by adding 80 mL of ion-exchanged water thereto. The thus-obtained dispersion liquid is subjected to the dispersion treatment for 3 minutes by an ultrasonic wave disperser (HONDA ELECTRONICS CO., LTD.). A concentration of the dispersion liquid is adjusted to a range of from 5,000 particles/μL through 15,000 particles/μL, and a shape and a distribution of the dispersion liquid are measured using the FPIA-2100.

In the measuring method of the present invention, it is important that a concentration of the dispersion liquid is adjusted to a range of from 5,000 particles/μL through 15,000 particles/μL, in terms of measurement reproducibility of the average circularity. In order to obtain the aforementioned concentration of the dispersion liquid, it is necessary to change conditions of the dispersion liquid (i.e., an amount of the surfactant to be added to the dispersion liquid, and an amount of the toner. Similar to the measurement of the toner particle diameter, a requisite amount of the surfactant is different depending on hydrophobicity of the toner. When the surfactant is excessively added to the dispersion liquid, the resultant toner contains foam, which may cause noise. When the surfactant is slightly added the dispersion liquid, it does not wet the toner, and thus dispersion may be insufficient. An amount of the toner added is different depending on a particle diameter. When the particle diameter is small, an amount of the surfactant may be slightly added to the dispersion liquid. When the particle diameter is large, it is necessary to excessively add the surfactant to the dispersion liquid. When the toner particle diameter is a range of from 3 μm through 10 μm, a concentration of the dispersion liquid can be adjusted to a range of from 5,000 particles/μL through 15,000 particles/μL by adding a range of from 0.1 g through 0.5 g of the surfactant to the dispersion liquid.

### —Volume Average Particle Diameter of Toner—

A volume average particle diameter of the toner is not particularly limited and may be appropriately selected depending on the intended purpose, but it is preferably a range of from 3 μm through 10 μm, more preferably a range of from 4 μm through 7 μm. When the volume average particle diameter is less than 3 μm, the resultant two-component developer may cause fusion of the toner particles on the surface of the carrier during stirring for a long term in a developing device, which results in reduction of charging ability of the carrier. When the volume average particle diameter is more than 10 μm, the resultant two-component developer makes it difficult to obtain an image having high resolution and high quality, which may lead to large fluctuation of particle diameters when the toner is supplied and consumed.

A ratio of the volume average particle diameter to the number average particle diameter (volume average particle diameter/number average particle diameter) is preferably a range of from 1.00 through 1.25, more preferably a range of from 1.00 through 1.15.

The volume average particle diameter, and the ratio of the volume average particle diameter to the number average particle diameter (volume average particle diameter/number average particle diameter) can be measured by a particle size determination apparatus (“Multisizer III”, product of Beckman Coulter, Inc.) with an aperture of 100 μm, and can be analyzed by an analysis software (Beckman Coulter Mutlisizer 3 Version 3.51).

Specifically, a 10% by mass surfactant (alkyl benzene sulfonate, NEOGEN SC-A, product of DKS Co. Ltd.) (0.5 mL) is added to a 100 mL-glass beaker, and each of the toners (0.5 g) is added to the beaker. Then, the mixture is stirred by a micro-spatula, followed by adding 80 mL of ion-exchanged water thereto. The obtained dispersion liquid is subjected to the dispersion treatment for 10 minutes by an ultrasonic wave disperser (W-113MK-II, product of HONDA ELECTRONICS CO., LTD.). The dispersion liquid is measured by the Multisizer III using ISOTON III (product of Beckman Coulter, Inc.) as a measurement solution. The toner sample dispersing liquid is added dropwise thereto so that a concentration of the toner indicated by the device is 8±2%. In the measurement of the present invention, it is important to adjust the concentration of the toner to 8±2% in terms of measurement repeatability of the particle diameter. There is no accidental error so long as the concentration of the toner falls within the aforementioned range.

### <Toner Components>

A toner of the present invention contains, in toner base particles, at least a binder resin, and further contains a release agent and other components if necessary. Also, an external additive can be added to the toner base particles if necessary.

### <<Binder Resin>>

The binder resin is not particularly limited and may be appropriately selected depending on the intended purpose. Examples of the binder resin include a polyester resin, a silicone resin, a styrene.acryl resin, a styrene resin, an acryl resin, an epoxy resin, a diene resin, a phenol resin, a terpene resin, a coumarin resin, an amide-imide resin, a butyral resin, a urethane resin, and an ethylene-vinyl acetate resin. These may be used alone or in combination.

Among them, a polyester resin and a resin obtained by combining a polyester resin with the aforementioned another binder resin are preferable because the resultant toner is excellent in low temperature fixing ability, and has enough flexibility even if the toner particles have lower molecular weight.

### —Polyester Resin—

The polyester resin is n particularly limited and may be appropriately selected depending on the intended purpose. Examples of the polyester resin include an unmodified polyester resin and a modified polyester resin. These may be used alone or in combination.

### —Unmodified Polyester Resin—

The unmodified polyester resin is not particularly limited and may be appropriately selected depending on the intended purpose. Examples of the unmodified polyester resin include a crystalline polyester resin, and a resin obtained, by reacting polyol represented by the following General Formula (1) and polycarboxylic acid represented by the following General Formula (2) to form polyester.

A-[OH]ₘ General Formula (1)

B—[COOH]ₙ General Formula (2)

Here, in the General Formula (1): A represents an alkyl group having 1 through 20 carbon atoms; an alkylene group having 1 through 20 carbon atoms, an aromatic group that may have a substituent, or a heterocyclic aromatic group that may have a substituent, and m represents an integer of a range of from 2 through 4. In the General Formula (2), B represents an alkyl group having a range of from 1 through 20 carbon atoms, an alkylene group having 1 to 20 carbon, atoms, an aromatic group that may have a substituent, or a heterocyclic aromatic group that may have a substituent, and n represents an integer of a range of from 2 through 4.

A polyol represented by the General Formula (1) is not particularly limited and may be appropriately selected depending on the intended purpose. Examples of the polyol represented by the General Formula (1) include ethylene glycol, diethylene glycol, triethylene glycol, 1,2-propylene glycol, 1,3-propylene glycol, 1,4-butanediol, neopentyl glycol, 1,4-butenediol, 1,5-pentanediol, 1,6-hexanediol, 1,4-cyclohexane dimethanol, dipropylene glycol, polyethylene glycol, polypropylene glycol, polytetramethylene glycol, sorbitol, 1,2,3,6-hexane tetrol, 1,4-sorbitan, pentaerythritol, dipentaerythritol, tripentaerythritol, 1,2,4-butanetriol, 1,2,5-pentanetriol, glycerol, 2-methylpropane triol, 2-methyl-1,2,4-butanetriol, trimethylolethane, trimethylolpropane, 1,3,5-trihydroxy methylbenzene, bisphenol A, bisphenol A ethylene oxide adduct, bisphenol A propylene oxide adduct, hydrogenated bisphenol A, hydrogenated bisphenol A ethylene oxide adduct, and hydrogenated bisphenol A propylene oxide adduct. These may be used alone or in combination.

The polycarboxylic acid represented by the General Formula (2) is not particularly limited and may be appropriately selected depending on the intended purpose. Examples of the polycarboxylic acid represented by the General Formula (2) include maleic acid, fumaric acid, citraconic acid, itaconic acid, glutaconic acid, phthalic acid, isophthalic acid, terephthalic acid, succinic acid, adipic acid, sebacic acid, azelaic acid, malonic acid, n-dodecenyl succinic acid, isooctyl succinic acid, isododecenyl succinic acid, n-dodecyl succinic acid, isododecyl succinic acid, n-octenyl succinic acid, n-octyl succinic acid, isooctenyl succinic acid, isooctyl succinic acid, 1,2,4-benzene tricarboxylic acid, 2,5,7-naphthalene tricarboxylic acid, 1,2,4-naphthalene tricarboxylic acid, 1,2,4-butane tricarboxylic acid, 1,2,5-hexane tricarboxylic acid, 1,3-dicarboxyl-2-methyl-2-methylene carboxypropane, 1,2,4-cyclohexane tricarboxylic acid, tetra(methylene carboxyl)methane, 1,2,7,8-octanetetra carboxylic acid, pyromellitic acid, empol trimer acid, cyclohexane dicarboxylic acid, cyclohexene dicarboxylic acid, butane tetracarboxylic acid, diphenylsulphone tetracarboxylic acid, and ethylene glycol bis(trimellitic acid). These may be used alone or in combination.

### —Modified Polyester Resin—

The modified polyester resin is not particularly limited and may be appropriately selected depending on the intended purpose. Examples of the modified polyester resin include a resin obtained reacting an active hydrogen group-containing compound with polyester that can react with the active hydrogen group-containing compound (hereinafter, referred to as “polyester prepolymer”) through the elongation reaction and/or the cross-linking reaction. The elongation reaction and/or the cross-linking reaction can be terminated by a reaction terminator (diethylamine, dibutylamine, butylamine, laurylamine, and a product obtained by blocking monoamine such as a ketimine compound) if necessary.

### —Active Hydrogen Group-Containing Compound—

The active hydrogen group-containing compound functions as a crosslinking agent and an elongating agent when the polyester prepolymer undergoes the elongation reaction and the cross-linking reaction in an aqueous medium.

The active hydrogen group-containing compound is not particularly limited and may be appropriately selected depending on the intended purpose, so long as it contains an active hydrogen group. Among them, amines are preferable because the polyester prepolymer is an isocyanate group-containing polyester prepolymer that will be described hereinafter, and thus toner particles having high molecular weight can be obtained.

The active hydrogen group is not particularly limited and may be appropriately selected depending on the intended purpose. Examples of the active hydrogen group include a hydroxyl group (alcoholic hydroxyl group or phenolic hydroxyl group), an amino group, a carboxyl group, and a mercapto group. These may be used alone or in combination.

The amines that are the active hydrogen group-containing compound are not particularly limited and may be appropriately selected depending on the intended purpose. Examples of the amines that are the active hydrogen group-containing compound include diamine, trivalent or higher polyamine, amino alcohol, amino mercaptan, amino acid, and a product obtained by blocking an amino group of the aforementioned amines.

Examples of the diamine include aromatic diamine (phenylenediamine, diethyltoluene diamine, and 4,4′-diaminodiphenylmethane); alicyclic diamine (4,4′-diamino-3,3′-dimethyldicyclohexyl methane, diamine cyclohexane, and isophoronediamine); and aliphatic diamine (ethylene diamine, tetramethylene diamine, and hexamethylenediamine).

Examples of the trivalent or higher polyamine include diethylenetriamine and triethylene tetramine.

Examples of the amino alcohol include ethanol amine and hydroxyethyl aniline Examples of the amino mercaptan include aminoethyl mercaptan and aminopropyl mercaptan.

Examples of the amino acid include amino propionic acid and amino caproic acid.

Examples of the product obtained by blocking an amino group of the aforementioned amines include an oxazoline compound and a ketimine compound obtained by reacting any of the amines (e.g., diamine, trivalent or higher polyamine, amino alcohol, amino mercaptan, and amino acid) with ketones (e.g., acetone, methyl ethyl ketone, and methyl isobutyl ketone).

These may be used alone or in combination. Among them, diamine, and a mixture of diamine and a small amount of trivalent or higher polyamine are particularly preferable as the amines. —Polymer that can React with Active Hydrogen Group-Containing Compound—

A polymer that can react with an active hydrogen group-containing compound is not particularly limited and may be appropriately selected depending on the intended purpose, so long as it contains a group that can react with the active hydrogen group-containing compound. Among them, a polyester resin containing a urea bond-generating group (RMPE) is preferable, and an isocyanate group-containing polyester prepolymer is more preferable, because the resultant toner is excellent in high flowability during melting and transparency; the molecular weight of high molecular components is easy to control; and a dry toner is excellent in oilless low temperature fixing ability and releasability.

The isocyanate group-containing polyester prepolymer is not particularly limited and may be appropriately selected depending on the intended purpose. Examples of the isocyanate group-containing polyester prepolymer include a polycondensate obtained by reacting polyol with polycarboxylic acid and a product obtained by reacting the active hydrogen group-containing polyester resin with polyisocyanate.

The polyol is not particularly limited and may be appropriately selected depending on the intended purpose. Examples of the polyol include: diols such as alkylene glycols (e.g., ethylene glycol, 1,2-propylene glycol, 1,3-propylene glycol, 1,4-butanediol, and 1,6-hexanediol), alkylene ether glycols (e.g., diethylene glycol, triethylene glycol, dipropylene glycol, polyethylene glycol, polypropylene glycol, and polytetramethylene ether glycol), alicyclic diols (e.g., 1,4-cyclohexane dimethanol and hydrogenated bisphenol A), bisphenols (e.g., bisphenol A, bisphenol F, and bisphenol S), adducts of the bisphenols with alkylene oxides (e.g., ethylene oxide, propylene oxide, and butylene oxide), and adducts of the alicyclic diol with alkylene oxide (e.g., ethylene oxide, propylene oxide, and butylene oxide); trivalent or more polyols such as polyvalent aliphatic alcohols (e.g., glycerin, trimethylolethane, trimethylolpropane, pentaerythritol, and sorbitol), trivalent or more phenols (e.g., phenol novolac, and cresol novolac), and adducts of trivalent or more polyphenol with alkylene oxide; and mixtures of diol and trivalent or more polyol.

These may be used alone or in combination. Among them, the polyol is preferably the diol alone, or a mixture of the diol and a small amount of the trivalent or more polyol.

The diol is preferably alkylene glycol having 2 through 12 carbon atoms and alkylene oxide adducts of bisphenols (e.g., bisphenol A ethylene oxide 2 mole adduct, bisphenol A propylene oxide 2 mole adduct, and bisphenol A propylene oxide 3 mole adduct).

An amount of the polyol in the isocyanate group-containing polyester prepolymer is not particularly limited and may be appropriately selected depending on the intended purpose, but it is preferably a range of from 0.5% by mass through 40% by mass, more preferably a range of from 1% by mass through 30% by mass, still more preferably a range of from 2% by mass through 20% by mass. When the amount of the polyol in the isocyanate group-containing polyester prepolymer is less than 0.5% by mass, the resultant toner may be deteriorated in hot offset resistance, and may have difficulty in achieving both storage property and low temperature fixing ability. When the amount of the polyol in the isocyanate group-containing polyester prepolymer is more than 40% by mass, the resultant toner may be deteriorated in low temperature fixing ability.

The polycarboxylic acid is not particularly limited and may be appropriately selected depending on the intended purpose. Examples of the polycarboxylic acid include: alkylene dicarboxylic acid (e.g., succinic acid, adipic acid, and sebacic acid); alkenylene dicarboxylic acid (e.g., maleic acid and fumaric acid); aromatic dicarboxylic acid (e.g., terephthalic acid, isophthalic acid, and naphthalene dicarboxylic acid); and trivalent or more polycarboxylic acid (aromatic polycarboxylic acid having 9 through 20 carbon atoms such as trimellitic acid and pyromellitic acid).

These may be used alone or in combination. Among them, the polycarboxylic acid is preferably alkenylene dicarboxylic acid having 4 through 20 carbon atoms or aromatic dicarboxylic acid having 8 through 20 carbon atoms. Note that, an anhydrate of polycarboxylic acid and lower alkylester (e.g., methyl eseter, ethylester, and isopropyl ester) can be used instead of the polycarboxylic acid.

A mixing ratio between the polyol and the polycarboxylic acid is not particularly limited and may be appropriately selected depending on the intended purpose. An equivalent ratio [OH]/[COOH] of the hydroxyl group [OH] in the polyol to the carboxyl group [COOH] in the polycarboxylic acid is preferably a range of from 2/1 through 1/1, more preferably a range of from 1.5/1 through 1/1, still more preferably a range of from 1.3/1 to 1.02/1.

The polyisocyanate is not particularly limited and may be appropriately selected depending on the intended purpose. Examples of the polyisocyanate include: aliphatic polyisocyanate (e.g., tetramethylene diisocyanate, hexamethylene diisocyanate, 2,6-diisocyanato methylcaproate, octamethylene diisocyanate, decamethylene diisocyanate, dodecamethylene diisocyanate, tetradecamethylene diisocyanate, trimethylhexane diisocyanate, and tetramethylhexane diisocyanate); alicyclic polyisocyanate (e.g., isophorone diisocyanate and cyclohexylmethane diisocyanate); aromatic diisocyanate (e.g., tolylene diisocyanate, diphenylmethane diisocyanate, 1,5-naphthylene diisocyanate, diphenylene-4,4′-diisocyanate, 4,4′-diisocyanato-3,3′-dimethyldiphenyl, 3-methyldiphenylmethane-4,4′-diisocyanate, and diphenylether-4,4′-diisocyanate); aromatic aliphatic diisocyanate (e.g., α,α,α′,α′-tetramethyl xylylene diisocyanate); isocyanurates (tris-isocyanatoalky-isocyanurate and triisocyanato cycloalkyl-isocyanurate); phenol derivatives of any of the aforementioned compounds; and a product obtained by blocking, for example, oxime or caprolactam. These may be used alone or in combination.

A mixing ratio between the polyisocyanate and the active hydrogen group-containing polyester resin (hydroxyl group-containing polyester resin) is not particularly limited and may be appropriately selected depending on the intended purpose. An equivalent ratio [NCO]/[OH] of the isocyanate group [NCO] in the polyisocyanate to the hydroxyl group [OH] in the hydroxyl group-containing polyester resin is preferably a range of from 5/1 through 1/1, more preferably a range of from 4/1 through 1.2/1, particularly preferably a range of from 3/1 through 1.5/1. When the equivalent ratio [NCO]/[OH] is less than 1/1, the resultant toner may be deteriorated in offset resistance. When the equivalent ratio [NCO]/[OH] is more than 5/1, the resultant toner may be deteriorated in low temperature fixing ability.

An amount of the polyisocyanate in the isocyanate group-containing polyester prepolymer is not particularly limited and may be appropriately selected depending on the intended purpose. The amount of the polyisocyanate in the isocyanate group-containing polyester prepolymer is preferably a range of from 0.5% by mass through 40% by mass, more preferably a range of from 1% by mass through 30% by mass, particularly preferably a range of from 2% by mass through 20% by mass. When the amount of the polyisocyanate in the isocyanate group-containing polyester prepolymer is less than 0.5% by mass, the resultant toner may be deteriorated in hot offset resistance, and may have difficulty in achieving both storage property and low temperature fixing ability. When the amount of the polyisocyanate in the isocyanate group-containing polyester prepolymer is more than 40% by mass, the resultant toner may be deteriorated in low temperature fixing ability.

An average number of the isocyanate group per one molecule of the isocyanate group-containing polyester prepolymer is preferably 1 or more, more preferably a range of from 1.2 through 5, still more preferably a range of from 1.5 through 4. When the average number of the isocyanate group per one molecule of the isocyanate group-containing polyester prepolymer is less than 1, a molecular weight of the polyester resin modified with the urea bond-generating group (RMPE) is low, and thus the resultant toner may be deteriorated in hot offset resistance.

A mixing ratio between the isocyanate group-containing polyester prepolymer and the amines is not particularly limited and may be appropriately selected depending on the intended purpose. A mixing equivalent ratio [NCO]/[NHx] of the isocyanate group [NCO] in the isocyanate group-containing polyester prepolymer to the amino group [NHx] in the amines is preferably a range of from 1/3 through 3/1, more preferably a range of from 1/2 through 2/1, still more preferably a range of from 1/1.5 through 1.5/1. When the mixing equivalent ratio ([NCO]/[NHx]) is less than 1/3, the resultant toner may be deteriorated in low temperature fixing ability. When the mixing equivalent ratio ([NCO]/[NHx]) is more than 3/1, a molecular weight of the urea-modified polyester resin is low, and thus the resultant toner may be deteriorated in hot offset resistance.

—Method for Synthesizing Polymer that can React with Active Hydrogen Group-Containing Compound—

A method for synthesizing the polymer that can react with an active hydrogen group-containing compound is not particularly limited and may be appropriately selected depending on the intended purpose. In cases where the isocyanate group-containing polyester prepolymer is produced, for example, a method for synthesizing the isocyanate group-containing polyester prepolymer is follows: the polyol and the polycarboxylic acid are heated to a range of from 150° C. through 280° C. in the presence of a known esterification catalyst (e.g., titanium tetrabutoxide or dibutyltin oxide), to obtain a hydroxyl group-containing polyester while reducing pressure in necessary for removing water; and the hydroxyl group-containing polyester is allowed to react with the polyisocyanate at a range of from 40° C. through 140° C., to obtain an isocyanate group-containing polyester prepolymer.

A weight average molecular weight (Mw) of the polymer that can react with an active hydrogen group-containing compound is not particularly limited and may be appropriately selected depending on the intended purpose. The weight average molecular weight of the polymer that can react with an active hydrogen group-containing compound is preferably a range of from 3,000 through 40,000, more preferably a range of from 4,000 through 30,000 in a molecular weight distribution obtained by measuring tetrahydrofuran (THF) soluble matter of the toner by GPC (gel permeation chromatography). When the weight average molecular weight (Mw) of the polymer that can react with an active hydrogen group-containing compound is less than 3,000, the resultant toner may be deteriorated in storage property. When the weight average molecular weight (Mw) of the polymer that can react with an active hydrogen group-containing compound is more than 40,000, the resultant toner may be deteriorated in low temperature fixing ability.

Measurement of the weight average molecular weight (Mw) can be performed as follows: First, a column is stabilized in a heat chamber at 40° C. Tetrahydrofuran (THF) as a column solvent is allowed to flow into the column at a velocity of 1 mL/min at 40° C. A tetrahydrofuran sample solution of a resin (a range of from 50 μL through 200 μL) obtained by adjusting a concentration of the sample to a range of from 0.05% by mass through 0.6% by mass is charged into the column, followed by performing measurement. In the measurement of the molecular weight of the sample, the molecular weight distribution of the sample is determined based on the relationship between the logarithmic value and the number of counts of the calibration curve given by using several monodisperse polystyrene-standard samples. The standard polystyrene samples used for giving the calibration curve are standard polystyrene samples having a molecular weight of 6×10², 2.1×10³, 4×10³, 1.75×10⁴, 1.1×10⁵, 3.9×10⁵, 8.6×10⁵, 2×10⁶, and 4.48×10⁶ (these products are Pressure Chemical Co. or Tosoh Corporation), and at least about 10 standard polystyrene samples are preferably used. Note that, as the detector, a refractive index (RI) detector can be used.

### —Crystalline Polyester Resin—

The toner has sharp melt property. In order to achieve toner properties advantageous for low temperature fixing ability, the toner has a glass transition point of a range of from 40° C. through 70° C. measured in a first temperature rising in measurement of DSC. When the glass transition point in a first temperature rising is defined as “X° C.”, the toner does not have a glass transition point falling within a range of from X through X-20° C. in a second temperature rising. The toner preferably contains a crystalline polyester resin as a binder resin in order to achieve the aforementioned glass transition points of the toner.

The crystalline polyester resin is preferably a crystalline polyester synthesized by reacting a saturated aliphatic diol compound having 2 through 12 carbon atoms as an alcohol component with at least one selected from the group consisting of dicarboxylic acid having a double bond (C═C bond) and 2 through 12 carbon atoms and a saturated dicarboxylic acid having 2 through 12 carbon atoms as an acid component. Examples of the alcohol component used for synthesizing the crystalline polyester resin include 1,4-butanediol, 1,6-hexanediol, 1,8-octanediol, 1,9-nonanediol, 1,10-decanediol, 1,12-dodecanediol, and derivatives thereof. Examples of the acid component used for synthesizing the crystalline polyester resin include fumaric acid, 1,4-butane dioic acid, 1,6-hexane dioic acid, 1,8-octanedioic acid, 1,10-decanedioic acid, 1,12-dodecane dioic acid, and derivatives thereof.

Among them, the crystalline polyester resin is preferably formed of at least one aliphatic alcohol components (e.g., 1,4-butanediol, 1,6-hexanediol, and 1,9-nonanediol) and at least one aliphatic dicarboxylic acid components (e.g., fumaric acid, sebacic acid, and 1,12-dodecane dioic acid) in order to lower a difference between an endothermic peak temperature and an endothermic shoulder temperature of the toner.

As a method for controlling crystallinity and a softening point of the crystalline polyester resin, a non-linear polyester is designed and used, where the non-linear polyester is produced through polycondensation by adding trivalent or higher polyvalent alcohol such as glycerin or trivalent or higher polyvalent carboxylic acid such as trimellitic anhydride to the acid component during producing polyester.

A molecular structure of the crystalline polyester resin can be confirmed by solution-state or solid-state NMR, X-ray diffraction, GC/MS, LC/MS, or IR spectroscopy.

An amount of the crystalline polyester resin in the toner is not particularly limited and may be appropriately selected depending on the intended purpose, but it is preferably a range of from 3% by mass through 15% by mass, more preferably a range of from 5% by mass through 10% by mass. When the amount of the crystalline polyester resin in the toner is 3% by mass or more, it is preferable that the resultant toner be excellent in low temperature fixing ability. When the amount of the crystalline polyester resin in the toner is 15% by mass or less, it is preferable that deterioration of heat storage property of the toner be difficult to cause.

“Being crystalline” in the present invention means that a ratio (softening temperature/maximum peak temperature of heat of fusion) of a softening temperature measured by an elevated flow tester to a maximum peak temperature of heat of fusion (melting point) measured by a differential scanning calorimetry (DSC) is a range of from 0.80 through 1.55, and that a material has property of being steeply softened with heat. A polyester resin having the aforementioned properties is referred to as “crystalline polyester resin”.

Note that, a softening temperature of the resin and the toner can be measured by an elevated flow tester (e.g., CFT-500D (product of SHIMADZU CORPORATION)). Specifically, while 1 g of a resin as a sample is heated at the heating rate of 6° C./min, a load of 1.96 MPa is applied by a plunger to extrude the sample from a nozzle having a diameter of 1 mm and a length of 1 mm. An amount of descent of the plunger of the flow tester is plotted versus the temperature. The temperature at which half of the sample is flown out is determined as a softening temperature of the sample.

A maximum peak temperature (melting point) of heat of fusion of the resin and the toner can be measured by a differential scanning calorimetry (DSC) (e.g., TA-60WS and DSC-60 (products of SHIMADZU CORPORATION)). Specifically, a sample provided for a measurement of the maximum peak temperature of heat of fusion is melted at 130° C. as a pretreatment, and then is cooled from 130° C. to 70° C. at a rate of 1.0° C./min, followed by cooling the sample from 70° C. to 10° C. at a ratio of 0.5° C./min. At this time, based on the DSC, the sample is heated at a heating rate of 20° C./min and is measured for an endothermic-exothermic change, and a graph of the endothermic/exothermic amount versus the temperature is drawn. In the graph, an endothermic peak temperature falling within a range from 20° C. to 100° C. is determined as “Ta*”. In the case where there are some endothermic peaks within the aforementioned temperature range, the temperature of the peak at which the endothermic amount is the highest is determined as Ta*. Thereafter, the sample is stored for 6 hours at (Ta*−10) ° C., and is further stored for 6 hours at (Ta*−15° C. Then, the above sample is cooled to 0° C. at the cooling rate of 10° C./min by DSC, and is heated at the heating rate of 20° C./min for measurement of the endothermic/exothermic change, followed by drawing a similar graph of the endothermic/exothermic amount versus the temperature. In the graph, a temperature corresponding to the maximum peak of the endothermic/exothermic amount is determined as a maximum peak temperature of heat of fusion.

### <<Release Agent>>

The release agent is not particularly limited and may be appropriately selected depending on the intended purpose. Examples of the release agent include: waxes such as a vegetable wax (e.g., carnauba wax, cotton wax, Japan wax, and rice wax), an animal wax (e.g., bees wax and lanolin), a mineral wax (e.g., ozokelite and ceresine), and a petroleum wax (e.g., paraffin, microcrystalline, and petrolatum); waxes other than the above natural waxes such as a synthetic hydrocarbon wax (e.g., Fischer-Tropsch wax and polyethylene wax) and a synthetic wax (e.g., ester wax, ketone, and ether); fatty acid amides such as 1,2-hydroxystearic acid amide, stearic amide, phthalic anhydride imide, and chlorinated hydrocarbons; and a crystalline polymer containing a long-chain alkyl group at a side chain of the polymer such as a homopolymer of polymethacrylic acid n-stearyl or polymethacrylic acid n-lauryl, which are a crystalline polymer having low molecular weight, and a copolymer (e.g., acrylic acid n-stearyl-methacrylic acid ethyl copolymer).

Among them, Fischer-Tropsch wax, paraffin wax, microcrystalline wax, monoester wax, and rice wax are preferable because an amount of an unnecessary volatile organic compounds generated during fixing is low.

As the release agent, a commercially available product can be used. Examples of the microcrystalline wax include: “HI-MIC-1045”, “HI-MIC-1070”, “HI-MIC-1080”, and “HI-MIC-1090” (all products of NIPPON SEIRO CO., LTD.); “BE SQUARE 180 WHITE” and “BE SQUARE 195” (all products of TOYO ADL CORPORATION); “BARECO C-1035” (product of WAX Petrolife); and “CRAYVALLAC WN-1442” (product of Cray Vally).

A melting point of the release agent is not particularly limited and may be appropriately selected depending on the intended purpose, but it is preferably a range of from 60° C. through 100° C., more preferably a range of from 65° C. through 90° C. When the melting point of the release agent is 60° C. or more, the release agent can be prevented from being oozed from the toner particles, and the resultant toner can be excellent in retaining heat resistant storage stability, even if the toner is stored at a high temperature of a range of from 30° C. through 50° C. When the melting point of the release agent is 100° C. or less, it is preferable that the toner can be prevented from causing cold offset during fixing at low temperature.

The melting point is measured by DSC. For example, TA-60WS and DSC-60 (all products of SHIMADZU CORPORATION) can be used to measure the melting point based on the following measurement conditions. Note that, “1st. heating” means a first temperature rising, and “2nd. heating” means a second temperature rising.

### [Measurement Conditions]

Sample container: aluminum sample pan (including lid)

Amount of sample: 5 mg

Reference: aluminum sample pan (alumina 10 mg)

Atmosphere: nitrogen (flow rate 50 mL/min)

Temperature Conditions

1st. heating: starting temperature: 20° C., heating rate: 10° C./min, end temperature: 150° C., retention time: nothing

1st. cooling: cooling rate: 10° C./min, end temperature: 20° C., retention time: nothing

2nd. heating: heating rate: 10° C./min, end temperature: 150° C.

A data analyzing software (TA-60, VERSION 1.52, product of SHIMADZU CORPORATION) is used to analyze the measurement results.

A temperature of a peak top of an endothermic peak measured in 2nd heating is used as the melting point.

The release agent is preferably present in a state of dispersing the release agent in the toner base particles. Therefore, the release agent is preferably incompatible with the binder resin. A method for finely dispersing the release agent in the toner base particles is not particularly limited and may be appropriately selected depending on the intended purpose. Examples of the method include a method for dispersing the release agent through shearing force during kneading the materials for producing the toner.

A state of dispersing the release agent can be confirmed by observing thin film slices of the toner particles by a transmission electron microscope (TEM). A diameter of the release agent dispersed is preferably small. However, the diameter of the release agent dispersed is too small, and thus the release agent may not be sufficiently oozed during fixing. Therefore, in cases where the release agent can be confirmed at ×10,000 magnification, the release agent exists in a state of being dispersed. In cases where the release agent cannot be confirmed at ×10,000 magnification, the release agent cannot be sufficiently oozed during fixing, even if it is finely dispersed.

An amount of the release agent in the toner is not particularly limited and may be appropriately selected depending on the intended purpose, but it is preferably a range of from 3% by mass through 15% by mass, more preferably a range of from 5% by mass through 10% by mass. When the amount of the release agent in the toner is less than 3% by mass, it is not preferable that the resultant toner may be deteriorated in hot offset resistance. When the amount of the release agent in the toner is more than 15% by mass, it is not preferable that an amount of the release agent oozed from the toner may be excessive, and thus the resultant toner be deteriorated in heat resistant storage stability.

### <<Other Components>>

### —Colorant—

A colorant used for the toner is not particularly limited and may be appropriately selected from known colorants depending on the intended purpose.

The color of the colorant used for the toner is not particularly limited and may be appropriately selected depending on the intended purpose, but it can be at least one selected from the group consisting of black toner, cyan toner, magenta toner, and yellow toner. The toner for each color can be obtained by appropriately selecting various colorants, but is preferably color toner.

Examples of a colorant for black include: carbon blacks (C.I. Pigment Black 7) such as Furnace black, Lamp black, Acetylene black, and Channel black; metals such as copper, iron (C.I. Pigment Black 11), and titanium oxide; and organic pigments such as aniline black (C.I. Pigment Black 1).

Examples of a pigment for magenta includes: C.I. Pigment Red series (1, 2, 3, 4, 5, 6, 7, 8, 9, 10, 11, 12, 13, 14, 15, 16, 17, 18, 19, 21, 22, 23, 30, 31, 32, 37, 38, 39, 40, 41, 48, 48:1, 49, 50, 51, 52, 53, 53:1, 54, 55, 57, 57:1, 58, 60, 63, 64, 68, 81, 83, 87, 88, 89, 90, 112, 114, 122, 123, 150, 163, 177, 179, 184, 202, 206, 207, 209, 211, and 269); Pigment Violet 19; and C.I. Vat Red series (1, 2, 10, 13, 15, 23, 29, and 35).

Examples of a pigment for cyan include: C.I. Pigment Blue series (2, 3, 15, 15:1, 15:2, 15:3, 15:4, 15:6, 16, 17, and 60); C.I. Vat Blue 6; C.I. Acid Blue 45; copper phthalocyanine pigment having a phthalocyanine skeleton and 1 through 5 phthalimidomethyl groups substituted thereto; Green 7; and Green 36.

Examples of a pigment for yellow include: C.I. Pigment Yellow series (1, 2, 3, 4, 5, 6, 7, 10, 11, 12, 13, 14, 15, 16, 17, 23, 55, 65, 73, 74, 83, 97, 110, 139, 151, 154, 155, 180, and 185); C.I. Vat Yellow series (1, 3, and 20); and Orange 36.

An amount of the colorant in the toner is preferably a range of from 1% by mass through 15% by mass, more preferably a range of from 3% by mass through 10% by mass. When the amount of the colorant in the toner is less than 1% by mass, the resultant toner may be deteriorated in coloring power. When the amount of the colorant in the toner is more than 15% by mass, the colorant is not sufficiently dispersed in the toner, and thus the resultant toner may be deteriorated in coloring power and electrical property.

The colorant may be used in the form of a master batch in which it is combined with a resin. The resin is not particularly limited, but a binder resin or a resin having the similar structure to the structure of the binder resin is preferable in terms of compatibility of the binder resin.

The master batch can be produced by mixing or kneading the resin and the colorant through high shearing force. In the mixing and kneading, an organic solvent may be added to the colorant and the resin in order to improve the interactions between the colorant and the resin. Moreover, the so-called flashing method is preferable because a wet cake can be used as it is, and is not necessary to dry. The flashing method is a method for removing water or an organic solvent by mixing or kneading an aqueous paste containing water of the colorant with the resin and the organic solvent, to transfer the colorant to the resin side. In the mixing and kneading, a high-shearing disperser such as a three-roll mill can be preferably used.

### —Charge Controlling Agent—

In order to impair appropriate charging ability to a toner, the toner can contain a charge controlling agent if necessary.

As the charge controlling agent, any of known charge controlling agents can be used. Use of the charge controlling agent containing colored materials may change a color tone of the toner, and thus the charge controlling agent preferably contains colorless materials or materials close to white. Examples of the charge controlling agent include triphenylmethane dyes, molybdic acid chelate pigments, rhodamine dyes, alkoxy amines, quaternary ammonium salts (including fluorine-modified quaternary ammonium salts), alkylamides, phosphorus or phosphorus compounds, tungsten or tungsten compounds, fluorine active agents, metal salts of salicylic acid, and metal salts of salicylic acid derivatives. These may be used alone or in combination.

An amount of the charge controlling agent is determined depending on a method for producing the toner, the method containing the kind of the binder resin and a method for dispersing the binder resin, and is not unambiguously limited. The amount of the charge controlling agent added is preferably a range of from 0.1% by mass through 5% by mass, more preferably a range of from 0.02% by mass through 2% by mass, relative to an amount of the binder resin. The amount of the charge controlling agent of more than 5% by mass may cause considerably high charging ability of the toner, reduction of an effect of the charge controlling agent, and high electrostatic attractive force to a developing roller, which may result in reduction of flowability of the developer and reduction of image density. The amount of the charge controlling agent of less than 0.01% by mass may cause insufficiency of charge rising and an amount of charge, which may influence a toner image.

### <<External Additive>>

The external additive is not particularly limited and may be appropriately selected from known external additives. Examples of the external additive include: silica fine particles, hydrophobic silica fine particles, fatty acid metal salts (e.g., zinc stearate and aluminum stearate); metal oxides (e.g., titania, alumina, tin oxide, and antimony oxide) or a hydrophobic product thereof, and fluoropolymer. Among them, hydrophobic silica fine particles, titania fine particles, and hydrophobic titania fine particles are preferable.

Examples of the hydrophobic silica fine particles include: HDK H 2000T, HDK H 2000/4, HDK H 2050EP, HVK 21, and HDK H 1303VP (all products of Clariant (Japan) K.K.); and R972, R974, RX200, RY200, R202, R805, R812, and NX90G (all products of Nippon Aerosil Co., Ltd.). Examples of the titania fine particles include: P-25 (product of Nippon Aerosil Co., Ltd.); STT-30 and STT-65C-S (both products of Titan Kogyo, Ltd.); TAF-140 (product of Fuji Titanium Industry Co., Ltd.); and MT-150 W, MT-500B, MT-600B, and MT-150A (all products of TAYCA CORPORATION).

Examples of the hydrophobic titanium oxide fine particles include: T-805 (product of Nippon Aerosil Co., Ltd.); STT-30A and STT-65S-S (both products of Titan Kogyo, Ltd.); TAF-500T and TAF-1500T (both products of Fuji Titanium Industry Co., Ltd.); T-100S and MT-100T (both products of TAYCA CORPORATION); and IT-S (product of ISHIHARA SANGYO KAISHA, LTD.).

An amount of the external additive is not particularly limited and may be appropriately selected depending on the intended purpose, but it is preferably a range of from 0.3 parts by mass through 3.0 parts by mass, more preferably a range of from 0.5 parts by mass through 2.0 parts by mass, relative to 100 parts by mass of the toner base particles.

A total coverage ratio of the external additive on the toner base particle is not particularly limited, but it is preferably a range of from 50% through 90%, more preferably a range of from 60% through 80%.

### (Method for Producing Toner)

As a method for producing a toner of the present invention and materials of the toner, all known methods and materials can be used without any limitation so long as these methods and materials satisfy the conditions. Examples of the methods include a kneading-pulverization method, and a chemical method in which toner particles are granulated in an aqueous medium.

Examples of the chemical methods include a suspension polymerization method, an emulsion polymerization method, a seed polymerization method, a dispersion polymerization method; a dissolution suspension method; a production method (I); an inverse emulsification method; and an aggregation method. Here, the suspension polymerization method, the emulsion polymerization method, the seed polymerization method, the dispersion polymerization method are methods for producing the toner using a monomer as a starting material. The dissolution suspension method is a method for producing the toner by dissolving a resin or a resin precursor in an organic solvent, to disperse or emulsify the resultant solution in an aqueous medium. The production method (I) includes part of the dissolution suspension method, and is a method for producing the toner by dispersing or emulsifying an oil composition in a resin fine particles-containing aqueous medium, to react an active hydrogen group-containing compound with reactive group-containing prepolymer in the aqueous medium, where the oil composition contains a resin precursor (reactive group-containing prepolymer) containing a functional group that can react with an active hydrogen group. The inverse emulsification method is a method for inverting a phase by adding water to a solution containing an appropriate emulsifying agent and a resin or a resin precursor. The aggregation method is a method in which resin particles obtained by these methods are aggregated in a state of being dispersed in an aqueous medium, to granulate particles having a desired size by heating and melting.

Among them, a toner obtained by the dissolution suspension method, the production method (I), or the aggregation method is preferable, a toner obtained by the production method (I) is more preferable, in terms of granulating property (e.g., controlling particle size distribution and controlling particle shape).

These methods will be described in detail hereinafter.

The kneading and pulverizing method is a method for producing toner base particles by pulverizing and classifying the melt-kneaded toner materials containing at least a colorant, a binder resin, and a release agent.

In the melt-kneading, the toner materials are mixed, and the resultant mixture is charged into a melt-kneader, followed by melt-kneading the resultant mixture. Examples of the melt-kneader include a single-screw or twin-screw continuous kneader, or a batch-type kneader with a roll mill. For example, a KTT type twin screw extruder (product of KOBE STEEL, Co.), a TEM type extruder (product of TOSHIBA MACHINE Co.), a twin screw extruder (product of KCK Engineering Co.), a PCM type twin screw extruder (product of Ikegai Co.), and a co-kneader (product of Buss Co.) are preferably used. The melt-kneading is preferably performed under such appropriate conditions that will not cause the cutting of the molecular chain in the binder resin. Specifically, a melt-kneading temperature is set considering a softening point of the binder resin. The melt-kneading temperature is higher than the softening point of the binder resin, which may result in severe cutting of the molecular chain. The melt-kneading temperature is too low, which may not proceed to dispersion.

In the pulverizing, the kneaded product obtained in the kneading is pulverized. In this pulverizing, it is preferable that the kneaded product be coarsely pulverized, followed by finely pulverizing the coarsely pulverized product. At this time, a method in which the kneaded product is pulverized by making the kneaded product to crush into an impact plate in the jet stream, a method in which the kneaded product is pulverized by making particles of the kneaded product to crush with each other in the jet stream, and a method in which the kneaded product is pulverized in a narrow gap between a mechanically rotating rotor and a stator are preferably used.

In the classifying, pulverized products obtained in the pulverizing are classified to adjust them to particles having a predetermined particle diameter. The classifying is performed by removing part of fine particles using a cyclone, a decanter, or a centrifugal separator.

After finishing the pulverizing and the classifying, the pulverized products can be classified through centrifugal force under a stream, to produce toner base particles having a predetermined particle diameter.

The dissolution suspension method is a method for producing toner base particles obtained by dispersing or emulsifying an oil phase composition in an aqueous medium, where the oil phase composition is obtained by dispersing or emulsifying, in an organic solvent, a toner composition containing at least binder resin or a resin precursor, a colorant, and a release agent.

As an organic solvent used for dissolving or dispersing the toner composition, a volatile organic solvent having a boiling point of less than 100° C. is preferably used because the subsequent operation of removing the solvent is easy to perform.

Examples of the organic solvent include: an ester solvent or an ester ether solvent such as ethyl acetate, butyl acetate, methoxybutyl acetate, methyl cellosolve acetate, and ethyl cellosolve acetate; an ether solvent such as diethyl ether, tetrahydrofuran, dioxane, ethyl cellosolve, butyl cellosolve, and propylene glycol monomethyl ether; a ketone solvent such as acetone, methyl ethyl ketone, methyl isobutyl ketone, di-n-butyl ketone, and cyclohexanone; an alcohol solvent such as methanol, ethanol, n-propanol, isopropanol, n-butanol, isobutanol, t-butanol, 2-ethylhexylalcohol, and benzyl alcohol; and a mixture solvent obtained in combination with two or more of the aforementioned solvents.

In the dissolution suspension method, an emulsifying agent or a dispersing agent may be used if necessary in order to disperse or emulsify an oil phase composition in an aqueous medium.

As the emulsifying agent or the dispersing agent, known surfactants and known water-soluble polymers can be used.

The surfactant is not particularly limited. Examples of the surfactant include an anionic surfactant (e.g., alkyl benzene sulfonic acid and phosphoric acid ester), a cationic surfactant (e.g., quaternary ammonium salt type and amine salt type), an amphoteric surfactant (e.g., carboxylic acid salt type, sulfuric acid ester salt type, sulfonic acid salt type, and phosphoric acid ester salt type), and a nonionic surfactant (e.g., AO-added type and polyvalent alcohol type). These surfactants may be used alone or in combination.

Examples of the water-soluble polymer include a cellulose compound (e.g., methyl cellulose, ethyl cellulose, hydroxyethyl cellulose, ethylhydroxyethyl cellulose, carboxy methyl cellulose, hydroxypropyl cellulose, and a saponified compound thereof), gelatin, starch, dextrin, Gum arabic, chitin, chitosan, polyvinyl alcohol, polyvinyl pyrrolidone, polyethylene glycol, polyethylene imine, polyacrylamide, an acrylic acid (salt)-containing polymer (e.g., polyacrylic acid sodium, polyacrylic acid potassium, polyacrylic acid ammonium, a product obtained by neutralizing a sodium hydroxide part of polyacrylic acid, and acrylic acid sodium-acrylic acid ester copolymer), a product obtained by neutralizing a sodium hydroxide part of styrene-maleic anhydride copolymer, and a water soluble polyurethane (e.g., a product obtained by reacting polyisocyanate with polyethylene glycol or polycaprolactone diol).

Moreover, the organic solvent and a plasticizing agent can be used together as an auxiliary agent for emulsification or dispersion.

A toner of the present invention is preferably obtained by a method (production method (I)) described as follows: in the dissolution suspension method, an oil phase composition is dispersed or emulsified in a resin fine particles-containing aqueous medium, and the reactive group-containing prepolymer is reacted with the at least one selected from the group consisting of the oil phase composition and an active hydrogen group-containing compound in an aqueous medium to granulate toner base particles, where the oil phase composition contains a binder resin, a binder resin precursor containing a group reactive to an active hydrogen group (reactive group-containing prepolymer), a colorant, and a release agent.

The resin fine particles can be formed by known polymerization method, but are preferably obtained by preparing an aqueous dispersion liquid of resin fine particles. As a method for preparing the aqueous dispersion liquid of resin fine particles, methods (a) to (h) can be used as described below.

(a) A method in which a vinyl monomer as a starting material is polymerized by the suspension polymerization method, the emulsification polymerization method, the seed polymerization method, or the dispersion polymerization method, to thereby directly prepare an aqueous dispersion liquid of resin fine particles.

(b) A method in which a precursor (e.g., a monomer or an oligomer) of a polyaddition resin or a condensation resin (e.g., a polyester resin, a polyurethane resin, or an epoxy resin) or a solvent solution thereof is dispersed in an aqueous medium in the presence of an appropriate dispersant, and then the resultant solution is cured by heating or by the addition of a curing agent, to thereby prepare an aqueous dispersion liquid of resin fine particles.

(c) A method in which an emulsifier is dissolved in a precursor (e.g., a monomer or an oligomer) of a polyaddition resin or a condensation resin (e.g., a polyester resin, a polyurethane resin, or an epoxy resin) or a solvent solution thereof (which is preferably liquid, or may be changed to liquid with heat), and is phase-inverted by the addition of water, to thereby prepare an aqueous dispersion liquid of resin fine particles.

(d) A method in which a resin that has previously been synthesized through polymerization reaction (e.g., addition polymerization, ring-opening polymerization, polyaddition, addition condensation, or condensation polymerization) is pulverized with a pulverizing mill, for example, mechanical rotation-type or jet-type, and is classified for obtaining resin fine particles, which are then dispersed in water in the presence of an appropriate dispersant, to thereby prepare an aqueous dispersion liquid of resin fine particles.

(e) A method in which a resin that has previously been synthesized through polymerization reaction (e.g., addition polymerization, ring-opening polymerization, polyaddition, addition condensation, or condensation polymerization) is dissolved in a solvent to prepare a resin solution, the resin solution is sprayed in the form of mist for obtaining resin fine particles, which are then dispersed in water in the presence of an appropriate dispersant, to prepare an aqueous dispersion liquid of resin fine particles.

(f) A method in which a resin that has previously been synthesized through polymerization reaction (e.g., addition polymerization, ring-opening polymerization, polyaddition, addition condensation, or condensation polymerization) is dissolved in a solvent to prepare a resin solution, and then a poor solvent is added to the resin solution, or the resin solution previously dissolved in a solvent is cooled, to precipitate resin fine particles, the solvent is removed for forming resin fine particles, which are then dispersed in water in the presence of a suitable dispersant, to thereby prepare an aqueous dispersion liquid of resin fine particles.

(g) A method in which a resin that has previously been synthesized through polymerization (e.g., addition polymerization, ring-opening polymerization, polyaddition, addition condensation, or condensation polymerization) is dissolved in a solvent to prepare a resin solution, the resin solution is dispersed in an aqueous medium in the presence of a suitable dispersant, and the solvent is removed by heating or under reduced pressure, to prepare an aqueous dispersion liquid of resin fine particles.

(h) A method in which a resin that has previously been synthesized through polymerization (e.g., addition polymerization, ring-opening polymerization, polyaddition, addition condensation, or condensation polymerization) is dissolved in a solvent to prepare a resin solution, an appropriate emulsifying agent is dissolved in the resin solution, the resultant solution undergoes phase-transfer emulsification by adding water thereto, to prepare an aqueous dispersion liquid of resin fine particles.

A volume average particle diameter of the resin fine particles is preferably 10 nm to 300 nm, more preferably 30 nm to 120 nm. When the volume average particle diameter of the resin fine particles is less than 10 nm or more than 300 nm, it is not preferable that the particle size distribution of the toner may be deteriorated.

A solid content concentration of the oil phase is preferably a range of from about 40% through about 80%. When the solid content concentration of the oil phase is too high, the toner materials are difficult to dissolve or disperse, a viscosity of the toner is high, and thus the resultant toner has difficulty in use. When the solid content concentration of the oil phase is too low, productivity of the toner may be deteriorated.

A toner composition other than the binder resin such as the colorant and the release agent, and a master batch of the above materials are each individually dissolved or dispersed in an organic solvent, to be mixed with a binder resin dissolving solution or a binder resin dispersing solution.

As the aqueous medium, water can be used alone, or a solvent capable of being mixed with water can be used in combination with the water. Examples of the solvent capable of being mixed with water include alcohols (e.g., methanol, isopropanol, and ethylene glycol), dimethyl formamide, tetrahydrofuran, cellosolves (e.g., methyl cellosolve), and lower ketones (e.g., acetone and methyl ethyl ketone).

A method for dispersing or emulsifying the oil phase in the aqueous medium is not particularly limited. Examples of the method for dispersing or emulsifying the oil phase in the aqueous medium include known equipment such as a low-speed shearing disperser, a high-speed shearing disperser, a friction disperser, a high-pressure jetting disperser, and an ultrasonic disperser. Among them, a high-speed shearing disperser is preferable in terms of making the particle size smaller. When a high-speed shearing disperser is used, a rotating speed of the high-speed shearing disperser is not particularly limited, but it is preferably a range of from 1,000 rpm through 30,000 rpm, more preferably a range of from 5,000 rpm through 20,000 rpm. A temperature at which the dispersion is performed using the high-speed shearing disperser is generally a range of from 0° C. through 150° C. (under pressurization), preferably a range of from 20° C. through 80° C.

A method for removing the organic solvent from the obtained emulsified dispersion is not particularly limited and known methods for removing the organic solvent can be used. A method in which the temperature is gradually increased under normal pressure or reduced pressure with stirring, to evaporate and remove the organic solvent in droplets can be employed.

As a method for washing and drying toner base particles dispersed in an aqueous medium, known techniques can be used. That is, solid-liquid separation is performed by a centrifugal separator or a filter press, the thus-obtained toner cake is re-dispersed in a deionized-water of normal temperature through about 40° C., and then a pH of the dispersed material is adjusted with an acid or an alkaline if necessary.

Then, a step of the solid-liquid separation is repeated several times to remove impurity products or the surfactant. Then, the thus-obtained product is dried with a flash dryer, a circulation dryer, a vacuum dryer, and a vibration flash dryer, to obtain toner powders. At this time, a component of toner fine particles may be removed through centrifugation. A desired particle size distribution can be obtained using a known classifying device after drying, if necessary.

The aggregation method is a method for producing toner base particles by mixing a resin fine particles dispersion liquid containing a binder resin, a colorant particles dispersion liquid, and a release agent particles dispersion liquid (if necessary) for aggregation. The resin fine particles dispersion liquid can be obtained through known methods such as the emulsification polymerization, the seed polymerization, and the phase-inversion. The colorant particles dispersion liquid and the release agent particles dispersion liquid can be obtained by dispersing a colorant or a release agent in an aqueous medium by a known wet dispersion method.

In order to control the aggregated state, it is preferable that heat be applied thereto, that a metal salt be added thereto, and that a pH of the toner be adjusted.

A metal forming the metal salt is not particularly limited. Examples of the metal forming the metal salt include a monovalent metal forming sodium salts and potassium salts; a divalent metal forming calcium salts and magnesium salts; and a trivalent metal forming aluminum salts.

Examples of an anion forming the metal salt include a chloride ion, a buromide ion, an iodide ion, a carbonate ion, and a sulfate ion. Among them, magnesium chloride, aluminum chloride, a complex thereof, and a multimer thereof are preferable.

The heating is preferably performed in the course of the aggregation or after the aggregation, which can promote fusion between the resin fine particles in terms of uniformity of the resultant base particles. Moreover, it is possible to control the shape of the toner by the heating. The base particles become closer to a spherical shape by further applying heat thereto.

A method for washing and drying the toner base particles dispersed in the aqueous medium can be performed by the aforementioned methods.

In order to improve flowability, storage stability, develop ability, and transferability of the toner, coalesced particles are added to the toner base particles produced as described above and are mixed, but inorganic fine particles such as hydrophobic silica fine powders may be added to the toner base particles and are mixed.

A general powders mixer is used to mix an additive agent, and is preferably adjustable in its inner temperature by a jacket or the like provided to the mixer. Note that, the additive agent may be added gradually or in the course of the mixing, in order to change the history of the load applied to the external additive. In this case, the number of rotations, a rotation speed, a mixing time, and a temperature of the mixer may be changed. Also, a large load may be initially applied to the additive agent, and next a relatively small load may be applied thereto, or vice versa.

As a mixing equipment, a V-type Mixer, a Rocking Mixer, a Lodige Mixer, a Nauta Mixer, and a Henschel Mixer can be used. Next, the resultant mixture may be passed through a sieve of 250 mesh or more, and thus coarse particles and aggregation particles are removed, to obtain the toner.

### (Developer)

A developer of the present invention contains at least the toner, further contains other components appropriately selected such as a carrier. The developer may be a one-component developer or a two-component developer. However, the two-component developer is preferably used for recent high-speed printers responding to improved information processing speed, in terms of improvement of lifetime of the printer.

When the toner is used for the one-component developer, the toner particles is prevented from aggregation due to stress applied from the developing unit over time, filming on the developing roller, and fusion on a layer-thickness regulating member such as a blade configured to thin a toner layer. Therefore, stability of image density and transfer property are favorably maintained, and thus an image having good and stable quality can be obtained.

When the toner is used for the two-component developer, aggregation of the toner particles due to stress applied from the developing unit does not easily occur over time, so that formation of an abnormal image is suppressed, and thus stability of image density and transfer property can be favorably maintained, which leads to excellent and stable image quality.

### <Carrier>

The carrier is not particularly limited and may be appropriately selected depending on the intended purpose, but it preferably contains core particles and a resin layer (coating layer) coating the core particles.

### <<Core Particles>>

The core particles are not particularly limited and may be appropriately selected depending on the intended purpose, so long as it has magnetism. Examples of the core particles include resin particles obtained by dispersing a magnetic material such as a ferromagnetic metal (e.g., iron and cobalt); and iron oxide (e.g., magnetite, hematite, and ferrite) in a resin. Among them, Mn ferrite, Mn—Mg ferrite, and Mn—Mg—Sr ferrite are preferable because they are environmental friendly.

### —Weight Average Particle Diameter (Dw) of Core Particles—

A weight average particle diameter (Dw) of the core particles is a particle diameter at an integrated value of 50% in the particle size distribution obtained by a laser diffraction scattering method. A weight average particle diameter (Dw) of the core particles is not particularly limited and may be appropriately selected depending on the intended purpose, it is preferably a range of from 10 μm through 80 μm, more preferably a range of from 20 μm through 65 μm.

A weight average particle diameter (Dw) of the core particles can be calculated from the following Formula (I) based on the particle size distribution of the particles (relation between number frequency and particle diameter) measured on a number basis with micro track particle size analyzer HRA9320-X100 (product of Honewell Co.). Here, each channel is a length for dividing the range of the particle diameters in the particle size distribution diagram into a unit width for measurement. A lower limit value of particle diameter stored in each channel is used as a representative particle diameter.

Dw={1/Σ(nD₃)}×{(nD₄)} (I)

where, in the Formula (I), D represents a representative particle diameter (μm) of core particles present in each channel, and n represents the total number of core particles present in each channel.

### [Measurement Conditions]

[1] Particle diameter range: a range of from 8 μm through 100 μm
[2] Channel length (channel width): 2 μm
[3] Number of channels: 46
[4] Refraction index: 2.42

### <<Coating Layer>>

The coating layer preferably contains at least a resin, further contains other components such as a filler.

### —Resin—

A resin used for forming a coating layer of a carrier is not particularly limited and may be appropriately selected depending on the intended purpose. Examples of the resin include: a crosslinkable copolymer product including, for example, polyolefin (e.g., polyethylene and polypropylene) or a modified product thereof, a polystyrene.acryl resin, acrylonitrile, vinyl acetate, vinyl alcohol, vinyl chloride, vinyl carbazole, and vinyl ether; a silicone resin containing an organosiloxane bond or a modified product thereof (e.g., a modified product of an alkyd resin, a polyester resin, an epoxy resin, polyurethane, and polyimide); polyamide; polyester; polyurethane; polycarbonate; a urea resin; a melamine resin; a benzoguanamine resin; an epoxy resin; an ionomer resin; a polyimide resin; and a derivative thereof. These may be used alone or in combination. Among them, a silicone resin is preferable.

The silicone resin is not particularly limited and may be appropriately selected from the generally-known silicone resins depending on the intended purpose. Examples of the silicone resin a straight silicone resin containing only an organosiloxane bond, and a silicone resin modified with alkyd, polyester, epoxy, acryl, and urethane.

Examples of the straight silicone resin include: KR271, KR272, KR282, KR252, KR255, and KR152 (all products of Shin-Etsu Chemical Co., Ltd.); and SR2400, SR2405, SR2406 (all products of Dow Corning Toray Co., Ltd.).

Specific examples of the above modified silicone resin include an epoxy-modified product (ES-1001N), an acryl-modified silicone (KR-5208), a polyester-modified product (KR-5203), an alkyd-modified product (KR-206), a urethane-modified product (KR-305) (all products of Shin-Etsu Chemical Co., Ltd.), and an epoxy-modified product (SR2115) and an alkyd-modified product (SR2110) (all products of Dow Corning Toray Co., Ltd.).

Note that, the silicone resin can be used alone, but can be used in combination of a crosslinkage reactive component and a charge amount adjusting component.

Examples of the crosslinkage reactive component include a silane coupling agent. Examples of the silane coupling agent include methyl trimethoxysilane, methyl triethoxysilane, octyltrimethoxysilane, and an aminosilane coupling agent.

### —Filler—

The filler is not particularly limited and may be appropriately selected depending on the intended purpose. Examples of the filler include an electroconductive filler and a non-electroconductive filler. These may be used alone or in combination. Among them, the filler preferably contains the coating layer containing the electroconductive filler and the non-electroconductive filler.

The electroconductive filler means a filler having a powder electric specific resistance value of 100 Ω·cm or less.

The non-electroconductive filler means a filler having a powder electric specific resistance value of more than 100 Ω·cm.

Measurement of a powder electric specific resistance value of the filler can be performed using a powder resistance measurement system (MCP-PD51, product of Daia Instruments) and a resistivity meter (4-terminal and 4-probe type, Loresta-GP, product of Mitsubishi Chemical Analytech Co.) under the following conditions: sample; 1.0 g, electrode interval; 3 mm, radius of sample; 10.0 mm, load; 20 kN.

### —Electroconductive Filler—

The electroconductive filler is not particularly limited and may be appropriately selected depending on the intended purpose. Examples of the electroconductive filler include: an electroconductive filler in which a layer of tin dioxide or indium oxide is formed on a base such as aluminum oxide, titanium oxide, zinc oxide, barium sulfate, and silicon oxide; and an electroconductive filler formed by using carbon black. Among them, an electroconductive filler containing aluminum oxide, titanium oxide, or barium sulfate is preferable.

### —Non-Electroconductive Filler—

The non-electroconductive filler is not particularly limited and may be appropriately selected depending on the intended purpose. Examples of the non-electroconductive filler include a non-electroconductive filler made using, for example, aluminum oxide, titanium oxide, barium sulfate, zinc oxide, silicon dioxide, or zirconium oxide. Among them, a non-electroconductive filler containing aluminum oxide, titanium oxide, or barium sulfate is preferable.

### <<Method for Producing Carrier>>

A method for producing the carrier is not particularly limited and may be appropriately selected depending on the intended purpose. A method in which the surface of the core particle is coated with a coating layer forming solution containing the resin to form a carrier is preferable. Note that, when the surface of the core particle is coated with the coating layer forming solution, the resin contained in the coating layer may undergo condensation. Alternatively, after the surface of the core particle is coated with the coating layer forming solution, the resin contained in the coating layer may undergo condensation. A method for condensing the resin is not particularly limited and may be appropriately selected depending on the intended purpose. Examples of the method for condensing the resin include a method for condensing the resin by applying heat or light to the coating layer forming solution. —Weight Average Particle Diameter (Dw) of Carrier—

A weight average particle diameter (Dw) of the carrier is a particle diameter of the core particles at an integrated value of 50% in the particle size distribution obtained by a laser diffraction scattering method. A weight average particle diameter (Dw) of the carrier is not particularly limited and may be appropriately selected depending on the intended purpose, it is preferably a range of from 10 μm through 80 μm, more preferably a range of from 20 μm through 65 μm.

A weight average particle diameter (Dw) of the carrier can be calculated from the following Formula (II) based on the particle size distribution of the particles (relation between number frequency and particle diameter) measured on a number basis with micro track particle size analyzer HRA9320-X100 (product of Honewell Co.). Here, each channel is a length for dividing the range of the particle diameters in the particle size distribution diagram into a unit width for measurement. A lower limit value of particle diameter stored in each channel is used as a representative particle diameter.

Dw={1/Σ(nD3)}×{Σ(nD4)} (II)

where, in the Formula (II), D represents a representative particle diameter (μm) of a carrier present in each channel, and n represents the total number of particles present in each channel.

### [Measurement Conditions]

[1] Particle diameter range: a range of from μm through 100 μm
[2] Channel length (channel width): 2 μm
[3] Number of channels: 46
[4] Refraction index: 2.42

When the developer is a two-component developer, a ratio of the toner to the carrier in the two-component developer is a range of from 2.0% by mass through 12.0% by mass, more preferably a range of from 2.5% by mass through 10.0% by mass, relative to an amount of the carrier.

### (Toner Stored Unit)

A toner stored unit of the present invention stores a toner in a unit having a function of storing the toner. Here, aspects of the toner stored unit are, for example, a toner stored container, a developing device, and a process cartridge.

The toner stored container is a container storing a toner.

The developing device includes a unit storing a toner, and configured to perform development.

The process cartridge integrally includes an image bearer and a developing unit, stores a toner, and is detachable to an image forming apparatus. The process cartridge may further include at least one selected from the group consisting of a charging unit, an exposing unit, and a cleaning unit.

A toner stored unit of the present invention is mounted on an image forming apparatus to form an image, and thus a toner of the present invention is used to form an image, which can lead to excellence in low temperature fixing ability, charging stability, and storage stability.

### (Image Forming Method and Image Forming Apparatus)

An image forming method used in the present invention includes: at least an electrostatic latent image forming step (charging step and exposing step), a developing step, a transfer step, and a fixing step; and further includes: other steps appropriately selected depending on the intended purpose, such as a charge-eliminating step, a cleaning step, a recycling step, and a controlling step.

An image forming apparatus of the present invention includes: at least an electrostatic latent image bearer; a charging unit configured to charge the surface of the electrostatic latent image bearer; an exposing unit configured to expose the charged surface of the electrostatic latent image bearer to form an electrostatic latent image; a developing unit configured to sequentially develop the electrostatic latent images with a plurality of color toners to form a visible image; a transfer unit configured to transfer the visible image to form a transferred image on a recording medium; and a fixing unit configured to fix the transferred image on the recording medium. The image forming apparatus of the present invention includes other units appropriately selected depending on the intended purpose, such as a charge-eliminating unit, a cleaning unit, a recycling unit, and a controlling unit.

### —Electrostatic Latent Image Forming Step and Electrostatic Latent Image Forming Unit—

The electrostatic latent image forming step is a step of forming an electrostatic latent image on an electrostatic latent image bearer.

A material, a shape, a structure, and a size of the electrostatic latent image bearer (may be referred to as “electrophotographic photoconductor” and “photoconductor”) are not particularly limited and may be appropriately selected from known electrostatic latent image bearers. Examples of the shape of the electrostatic latent image bearer include a drum shape. Examples of the material of the electrostatic latent image bearer include an inorganic photoconductor (e.g., amorphous silicon and selenium), and an organic photoconductor (OPC) (e.g., polysilane and phthalopolymethine). Among them, an organic photoconductor (OPC) is preferable because an image with higher fineness can be obtained.

The electrostatic latent image can formed by an electrostatic latent image forming unit, where the electrostatic latent image forming unit uniformly charges the surface of the electrostatic latent image bearer, followed by imagewise exposing.

The electrostatic latent image forming unit includes: at least a charging unit (charging device) configured to uniformly charge the surface of the electrostatic latent image bearer; and an exposing unit (exposing device) configured to imagewise expose the surface of the electrostatic latent image bearer.

For example, the charging can be performed by applying a voltage to a surface of the electrostatic latent image bearer using the charging device.

The charging device is not particularly limited and may be appropriately selected depending on the intended purpose. Examples of the charging device include known contact charging devices, equipped with an electroconductive or semiconductive roller, brush, film, or rubber blade, and a non-contact charging device utilizing corona discharge, such as corotron and scorotron.

It is preferred that the charging device be provided in contact with the electrostatic latent image bearer, or in non-contact with the electrostatic latent image bearer, and the surface of the electrostatic latent image bearer be charged by applying superimposed AC voltage and DC voltage.

Moreover, it is preferred that the charging device be charging roller disposed adjacent to the electrostatic latent image bearer in a non-contact manner via a gap tape, and configured to charge the surface of the electrostatic latent image bearer by applying superimposed AC voltage and DC voltage to the charging roller.

The exposure can be performed by imagewise exposing the surface of the electrostatic latent image bearer using the exposing device.

The exposing device is not particularly limited and may be appropriately selected depending on the intended purpose, so long as it can imagewise expose the surface of the electrostatic latent image bearer charged by the charging device. Examples of the exposing device include various exposure devices, such as a copy optical system, a rod lens array system, a laser optical system, and a crystal shutter optical system.

Note that, in the present invention, a back side system may be employed, where the back side system means that imagewise exposure is performed from the back side of the electrostatic latent image bearer.

### —Developing Step and Developing Unit—

The developing step is a step of developing the electrostatic latent image using the toner, to form a visible image.

The visible image can be formed by the developing unit, for example, by developing the electrostatic latent image using the toner.

The developing unit suitably contains at least, for example, a developing device that stores the toner, and configured to apply the toner to the electrostatic latent image in a contact or non-contact manner. A developing device including a container with the toner is more preferable.

The developing unit may be a developing unit for a single color, or a developing unit for multicolor. Examples of the developing device include a developing device containing a stirring device configured to stir the toner by friction to be charged and a rotatable magnetic-roller.

In the developing unit, toner particles and carrier particles are stirred and mixed so that the toner particles are charged by friction generated therebetween. The charged toner particles are retained in the chain-like form on the surface of the rotating magnetic roller to form magnetic brushes. The magnetic roller is disposed near the electrostatic latent image developing member (photoconductor), and thus some of the toner particles that form the magnetic brushes formed on the surface of the magnet roller are transferred onto the surface of the electrostatic latent image developing member (photoconductor) by the action of electrically attractive force. As a result, the electrostatic latent image is developed with the toner particles to form a visible image on the surface of the electrostatic latent image developing member (photoconductor).

### —Transfer Step and Transfer Unit—

The transfer step is a step of transferring the visible image onto a recording medium. The transfer step is preferably an aspect where an intermediate transfer member is used to primarily transfer a visible image onto the intermediate transfer member, to secondarily transfer the thus-transferred visible image onto the recording medium. The transfer step is more preferably an aspect including a primary transfer step and a secondary transfer step, where the primary transfer step is a step of transferring a visible image onto an intermediate transfer member using two or more toners, preferably toners of full colors, to form a composite transfer image, and the secondary transfer step is a step of transferring the composite transfer image onto a recording medium.

The transferring can be performed by the transfer unit, for example, by charging the visible image on the electrostatic latent image bearer (photoconductor) using a transfer charger. Examples of the transfer unit include an aspect including a primary transfer unit and a secondary transfer unit, where the primary transfer unit is configured to transfer a visible image onto an intermediate transfer member to form a composite transfer image, and the secondary transfer unit is configured to transfer the composite transfer image on a recording medium.

Note that, the intermediate transfer member is not particularly limited and may be appropriately selected from known transfer members depending on the intended purpose. Examples of the intermediate transfer member suitably include a transfer belt.

The transfer unit (the primary transfer unit and the secondary transfer unit) preferably includes at least a transfer device configured to charge the visible images formed on the electrostatic latent image developing member (photoconductor) onto the recording medium to be transferred onto the recording medium. The number of the transfer unit may be one, or two or more.

Examples of the transfer device include a corona transfer device employing corona discharge, a transfer belt, a transfer roller, a pressing transfer roller, and an adhesive transferring device.

The recording medium is not particularly limited and may be appropriately selected from known recording medium (recording paper).

### —Fixing Step and Fixing Unit—

The fixing step is a step of fixing a visible image transferred on recording medium by a fixing device. The fixing step may be performed every time when an image of each color toner is transferred onto the recording medium, or the fixing step may be performed at one time in a state that images of color toners are superposed.

The fixing device is not particularly limited and may be appropriately selected depending on the intended purpose, but it is preferably a known heating-pressurizing unit. Examples of the heating-pressurizing unit include a combination of a heat roller and a press roller, and a combination of a heat roller, a press roller, and an endless belt.

The fixing device includes: a heating member containing a heat generating element; a film configured to contact with the heating member; and a pressurizing member configured to be pressed against the heating member via the film. The fixing device is preferably a unit configured to pass recording medium on which an unfixed image is formed between the film and the pressurizing member, to fix the recording medium with heat. The heating-pressurizing unit usually performs heating preferably at a range of from 80° C. through 200° C.

Note that, in the present invention, known photofixing devices may be used instead of or in addition to the fixing step and the fixing unit depending on the intended purpose.

The charge-eliminating step is a step of applying a charge-eliminating bias to the electrostatic latent image bearer, to eliminate charge, and can be performed by a charge-eliminating unit.

The charge-eliminating unit is not particularly limited and may be appropriately selected from known charge-eliminating devices depending on the intended purpose, so long as it apply a charge-eliminating bias to the electrostatic latent image bearer. Examples of the charge-eliminating unit include a charge-eliminating lamp.

The cleaning step is not particularly limited so long as it can remove the toner remaining on the electrostatic latent image bearer, and can be suitably performed by a cleaning unit.

The cleaning step is not particularly limited and may be appropriately selected from known cleaners so long as it can remove the toner reaming on the electrostatic latent image bearer. Examples of the cleaning unit include a magnetic brush cleaner, an electrostatic brush cleaner, a magnetic roller cleaner, a blade cleaner, a brush cleaner, and a web cleaner.

The recycling step is a step of recycling the toner removed by the cleaning step to the developing unit, and can be suitably performed by a recycling unit. The recycling unit is not particularly limited. Examples of the recycling unit include known conveying units.

The controlling step is a step of control each of the above steps, and each of the steps can be suitably performed by a controlling unit.

The controlling unit is not particularly limited and may be appropriately selected depending on the intended purpose, so long as it can control each of the above units. Examples of the controlling unit include devices such as a sequencer and a computer.

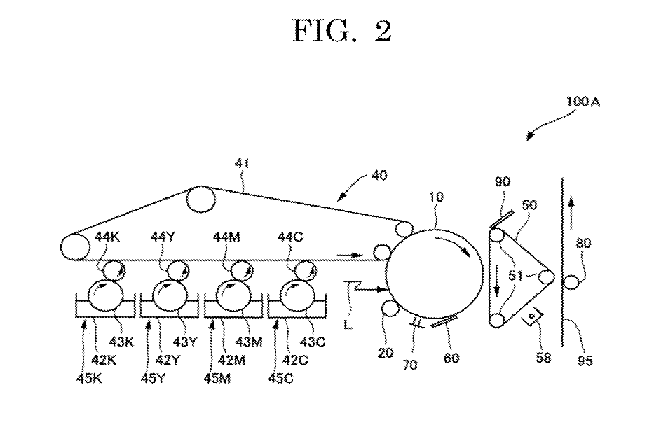

FIG. 2 illustrates one example of an image forming apparatus of the present invention. An image forming apparatus 100A includes a photoconductor drum 10, a charging roller 20, an exposing device, a developing device 40, an intermediate transfer belt 50, a cleaning device 60 containing a cleaning blade, and a charge-eliminating lamp 70.

The intermediate transfer belt 50, which is an endless belt, is stretched around three rollers 51 disposed in the belt, and is movable in a direction indicated by the arrow of the figures. Apart of three rollers 51 also functions as a transfer bias roller that can apply a transfer bias (primary transfer bias) to the intermediate transfer belt 50. Near the intermediate transfer belt 50, a cleaning device 90 including a cleaning blade is disposed. Also, a transfer roller 80 that can apply a transfer bias (secondary transfer bias) onto a transfer paper 95 configured to transfer a toner image is disposed facing the intermediate transfer belt 50. Around the intermediate transfer belt 50, a corona charging device 58 configured to apply a charge to the toner image transferred on the intermediate transfer belt 50 is disposed between a contact portion of the photoconductor drum 10 with the intermediate transfer belt 50 and a contact portion of the intermediate transfer belt 50 with the transfer paper 95 in a rotational direction of the intermediate transfer belt 50.

The developing device 40 is composed of a developing belt 41; and a black developing unit 45K, a yellow developing unit 45Y, a magenta developing unit 45M, and a cyan developing unit 45C, which are disposed around the developing belt 41. A developing unit 45 for each color includes a developer storage unit 42, a developer supplying roller 43, and a developing roller 44 (developer bearing member). Moreover, the developing belt 41, which is an endless belt, is stretched around a plurality of rollers, and is movable in a direction indicated by the arrow of the figures. A part of the developing belt 41 contacts with the photoconductor drum 10.

Next, a method for forming an image using the image forming apparatus 100A will be described hereinafter. The surface of the photoconductor drum 10 is uniformly charged by the charging roller 20. Then, the exposing device (not illustrated) exposes the surface of the photoconductor drum 10 to light, to form an electrostatic latent image. Next, the electrostatic latent image formed on the photoconductor drum 10 is developed using the toner supplied from a developer from the developing device 40, to form a toner image. The toner image formed on the photoconductor drum 10 is transferred (primarily transferred) onto the intermediate transfer belt 50, and is further transferred (secondary transferring) onto the transfer paper 95 by a transfer bias applied from the transfer roller 80. Meanwhile, a residual toner remaining on the surface of the photoconductor drum 10, in which the toner image is transferred to the intermediate transfer belt 50, is removed by the cleaning device 60, and a charge on the surface of the photoconductor drum 10 is eliminated by the charge-eliminating lamp 70.

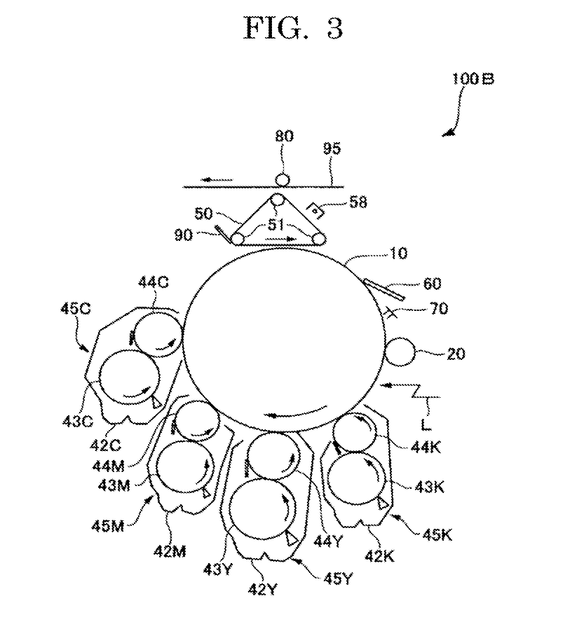

FIG. 3 is a second example of an image forming apparatus used in the present invention. An image forming apparatus 100B has the same configuration as the image forming apparatus 100A, except that the developing belt 41 is not disposed, and that the black developing unit 45K, the yellow developing unit 45Y, the magenta developing unit 45M, and the cyan developing unit 45C are disposed directly facing the periphery of the photoconductor drum 10.

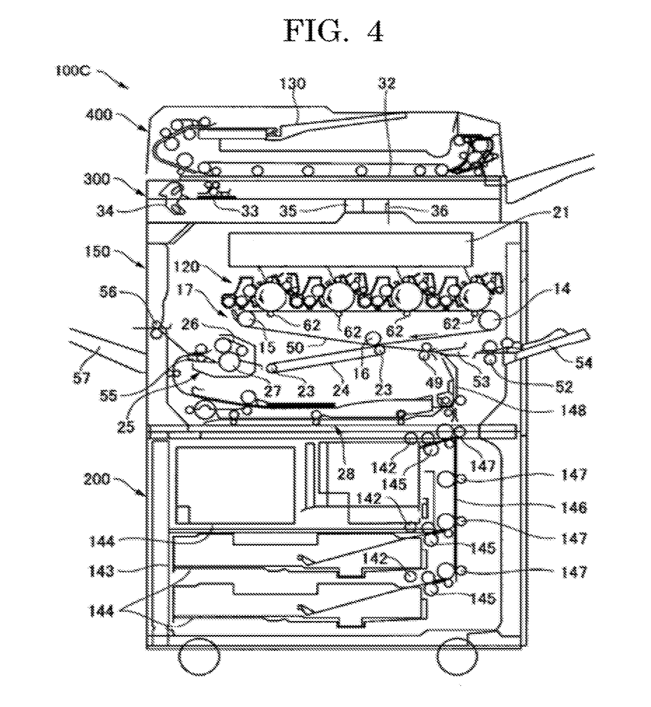

FIG. 4 illustrates a third example of an image forming apparatus used in the present invention. The image forming apparatus 100C is a tandem color image forming apparatus, and includes a copying device main body 150, a paper feeding table 200, a scanner 300, and an automatic document feeder (ADF) 400.

An intermediate transfer belt 50, which is an endless belt type, is disposed at a central part of the copying device main body 150. The intermediate transfer belt 50 is stretched around three rollers 14, 15, and 16, and can rotate in the direction indicated by the arrow in figures. Near the roller 15, a cleaning device 17 including a cleaning blade is disposed, and is configured to remove a residual toner on the intermediate transfer belt 50 in which the toner image is transferred to the recording paper. Image forming units for four colors (yellow, cyan, magenta, and black) 120Y, 120C, 120M, and 120K are aligned in the conveying direction so as to face the intermediate transfer belt 50 stretched around rollers 14 and 15.

Near the image forming unit 120, an exposing device 21 is disposed. Moreover, a secondary transfer belt 24 is disposed opposite to a side where the image forming unit 120 of the intermediate transfer belt 50 is disposed. The secondary transfer belt 24, which is an endless belt, is stretched around a pair of rollers 23. The recording paper conveyed on the secondary transfer belt 24 and the intermediate transfer belt 50 can contact each other between the roller 16 and the roller 23.

Near the secondary transfer belt 24, a fixing device 25 is disposed. The fixing device 25 includes a fixing belt 26 and a press roller 27, where the fixing belt 26, which is an endless belt, is stretched around a pair of rollers, and the press roller 27 is disposed so as to be pressed against the fixing belt 26. Here, a sheet inverting device 28 configured to invert the recording paper is disposed near the secondary transfer belt 24 and the fixing device 25, in order to form an image on both sides of the recording paper.

Next, a method for forming a full-color image using the image forming apparatus 100C will be described hereinafter. First, a color document is set on a document table 130 of the automatic document feeder (ADF) 400, or the automatic document feeder 400 is opened to set the color document on a contact glass 32 of the scanner 300, and the automatic document feeder 400 is closed.

When a start button is pushed, in the case where the color document has been set on the automatic document feeder 400, the color document is conveyed and transferred to the contact glass 32, and then the scanner 300 activates. Meanwhile, in the case the color document has been set on the contact glass 32, the scanner 300 activates immediately after that. Then, a first travelling body 33 including a light source and a second travelling body 34 including a mirror travel. At this time, the first travelling body 33 irradiates the document with light to form reflected light, the reflected light is reflected at the second travelling body 34, and then the reflected light is received at a reading sensor 36 through an imaging forming lens 35. Thus, the color document is read, to obtain black, yellow, magenta and cyan image information.

Each image information is transmitted to the image forming unit 120 for each color, to form a toner image for each color. As illustrated in FIG. 5, the image forming unit 120 for each color includes: a photoconductor drum 10; a charging roller 160 configured to uniformly charge the photoconductor drum 10; an exposing device configured to expose the photoconductor drum 10 to exposing light L based on image information for each color, to form an electrostatic latent image corresponding to form a color image; a developing device 61 configured to develop the electrostatic latent image with the toner for each color, to form a toner image of each of the color toners; a transfer roller 62 configured to transfer the toner image on the intermediate transfer belt 50; a cleaning device 63 including a cleaning blade; and a charge-eliminating lamp 64. The toner image for each color formed on the image forming unit 120 for each color is transferred (primarily transferred), and are superposed on top of one another on an intermediate transfer member 50, which is stretched around rollers 14, 15, and 16, and is movable, to form a composite color image.

Meanwhile, on the paper feeding table 200, one of paper feeding rollers 142 is selectively rotated to feed a recording paper from one of the paper feeding cassettes 144 equipped in multiple stages in a paper bank 143. The sheet is separated one by one by a separation roller 145 and sent to a paper feeding path 146. The recording paper is conveyed by a conveying roller 147 and is guided to a paper feeding path 148 in the copying device main body 150, and stops by colliding with a registration roller 49. Alternatively, the paper feeding roller 142 is rotated to feed a recording paper on a manual feed tray 54. The recording paper is separated one by one by a separation roller 52 and is guided to a manual paper feeding path 53, and stops by colliding with the registration roller 49. Note that, the registration roller 49 is generally used so as to be grounded, but it may also be used in a state that a bias is being applied for removing paper dust particles on the recording medium.

Next, the registration roller 49 is rotated in accordance with the timing of the composite toner image formed on the intermediate transfer belt 50, the recording paper is fed to between the intermediate transfer belt 50 and the secondary transfer belt 24, to transfer (secondarily transfer) the composite toner image on the recording medium. Notably, a residual toner remaining on the intermediate transfer belt 50, in which the composite toner is transferred thereto, is removed by the cleaning device 17.

The recording medium on which the composite toner image is transferred is conveyed by the secondary transfer belt 24, and then the composite toner image is fixed by the fixing device 25. Next, a conveying path is switched by a switching claw 55, and the recording medium is discharged in a paper ejection tray 57 by a discharge roller 56. Alternatively, a conveying path is switched by the switching claw 55, and the recording medium is inverted by the inverting device 28, to form an image on the rear surface of the recording medium. Then the recording medium is discharged in the paper ejection tray 57 by the discharge roller 56.

An image forming apparatus of the present invention can provide an image having high quality for a long term.

### EXAMPLES

Examples of the present invention now will be described, but the present invention is not limited thereto. In the following description, “%” means “% by mass” and “part(s)” means “part(s) by mass,” unless otherwise stated.

### Synthetic Example A-1

### Synthesis of Binder Resin A-1

A reaction container equipped with a nitrogen inlet tube, a water outlet tube, a stirrer, and a thermocouple was charged with 160 parts by mass of deionized water, 0.04 parts by mass of an aqueous sodium polyacrylate solution (solid content: 3.3% by mass), 0.01 parts by mass of Dispersing agent A produced according to the below described method, and 0.4 parts by mass of sodium sulfate, followed by adding with 80 parts by mass of styrene, 20 parts by mass of butyl acrylate, and 0.3 parts by mass of trimethylolpropane triacrylate, each of which served as a monomer component; and 2 parts by mass of benzoyl peroxide and 0.5 parts by mass of t-butyl peroxy-2-ethylhexyl monocarbonate, each of which served as a polymerization initiator. The reaction container was heated from 40° C. to 130° C. for 2 hours while contents therein were stirred. After reaching 140° C., the contents were allowed to be reacted with each other for another 3 hours to thereby obtain [Binder resin A-1].

### —Synthesis of Dispersing Agent A—

A reaction container equipped with a nitrogen inlet tube, a water outlet tube, a stirrer, and a thermocouple was charged with 2,300 parts by mass of deionized water, 25 parts by mass of methyl methacrylate, and 75 parts by mass of sodium 3-sulfopropyl methacrylate, followed by bubbling nitrogen gas for about 30 min. The reaction container was heated to 60° C. while contents therein were stirred, followed by adding with 0.5 parts by mass of ammonium persulfate and stirring for 3 hours to thereby obtain [Dispersing agent A].

### Synthetic Example A-2

### Synthesis of Binder resin A-2

A reaction container equipped with a nitrogen inlet tube, a water outlet tube, a stirrer, and a thermocouple was charged with 376 parts of bisphenol A propylene oxide 2 mol adduct and 109 parts of bisphenol A propylene oxide 3 mol adduct in a molar ratio of 80/20 (bisphenol A propylene oxide 2 mol adduct/bisphenol A propylene oxide 3 mol adduct), and 116 parts of isophthalic acid and 44 parts of adipic acid in a molar ratio of 70/30 (isophthalic acid/adipic acid) so as to be OH/COOH=1.33, followed by reacting together with 500 ppm of titanium tetraisopropoxide under normal pressure at 230° C. for 10 hours to thereby obtain a reaction product. Then, the reaction container was added with 26 parts of benzoic acid, followed by reacting under reduced pressure of a range of from 10 mmHg through 15 mmHg for 5 hours. Thereafter, the reaction container was added with 11 parts of trimellitic anhydride, followed by reacting under normal pressure at 180° C. for 3 hours to thereby obtain [Binder resin A-2].

### Synthetic Example A-3

### Synthesis of Binder Resin A-3

[Binder resin A-3] was obtained in the same manner as in Synthetic Example A-2, except that the molar ratio of isophthalic acid to adipic acid was changed from 70/30 to 50/50.

### Synthetic Example A-4

### Synthesis of Binder Resin A-4

[Binder resin A-4] was obtained in the same manner as in Synthetic Example A-2, except that the molar ratio of bisphenol A propylene oxide 2 mol adduct to bisphenol A propylene oxide 3 mol adduct was changed from 80/20 to 50/50, the molar ratio of isophthalic acid to adipic acid was changed from 70/30 to 100/0, and the OH/COOH was changed from 1.33 to 1.29.

### Synthetic Example A-5

### Synthesis of Binder Resin A-5

[Binder resin A-5] was obtained in the same manner as in Synthetic Example A-2, except that the amount of benzoic acid was changed from 26 parts to 16 parts.

### Synthetic Example A-6

### Synthesis of Binder Resin A-6

[Binder resin A-6] was obtained in the same manner as in Synthetic Example A-2, except that isophthalic acid and adipic acid in the molar ratio of 70/30 was changed to terephthalic acid and isophthalic acid in the molar ratio of 85/15 (terephthalic acid/isophthalic acid), and the OH/COOH was changed from 1.33 to 1.35.

### Synthetic Example A-7

### Synthesis of Binder Resin A-7

A reaction container equipped with a nitrogen inlet tube, a water outlet tube, a stirrer, and a thermocouple was charged with 282 parts of bisphenol A propylene oxide 2.2 mol adduct and 173 parts of bisphenol A ethylene oxide 2.2 mol adduct in a molar ratio of 60/40 (bisphenol A propylene oxide 2.2 mol adduct/bisphenol A ethylene oxide 2.2 mol adduct), and 76 parts of terephthalic acid, 65 parts of fumaric acid, and 40 parts of dodecenylsuccinic anhydride in a molar ratio of 46/39/15 (terephthalic acid/fumaric acid/dodecenylsuccinic anhydride) so as to be OH/COOH=1.2, followed by reacting together with 500 ppm of titanium tetraisopropoxide under normal pressure at 230° C. for 10 hours to thereby obtain a reaction product. Then, the reaction container was added with 26 parts of benzoic acid, followed by reacting under reduced pressure of a range of from 10 mmHg through 15 mmHg for 5 hours. Thereafter, the reaction container was added with 11 parts of trimellitic anhydride, followed by reacting under normal pressure at 180° C. for 3 hours to thereby obtain [Binder resin A-7].

### —Production of Masterbatch 1—

HENSCHEL MIXER (manufactured by NIPPON COKE & ENGINEERING COMPANY, LIMITED) was charged with 1,200 parts of water, 540 parts of carbon black (PRINTEX35, manufactured by Evonik Industries AG) [DBP oil absorption=42 mL/100 mg, pH=9.5], and 1,200 parts of [Binder resin A-2], followed by mixing together to thereby obtain a mixture. The mixture was kneaded at 150° C. for 30 min using a two-roll mill, followed by being roll-cooled and pulverized with a pulverizer to thereby obtain [Masterbatch 1].

### Synthetic Example B-1

### Synthesis of Binder Resin B-1

A reaction container equipped with a nitrogen inlet tube, a water outlet tube, a stirrer, and a thermocouple was charged with 376 parts of bisphenol A propylene oxide 2 mol adduct and 109 parts of bisphenol A propylene oxide 3 mol adduct in a molar ratio of 80/20 (bisphenol A propylene oxide 2 mol adduct/bisphenol A propylene oxide 3 mol adduct), and 116 parts of isophthalic acid and 44 parts of adipic acid in a molar ratio of 70/30 (isophthalic acid/adipic acid) so as to be OH/COOH=1.33, followed by reacting together with 500 ppm of titanium tetraisopropoxide under normal pressure at 230° C. for 10 hours. After further reacting under reduced pressure of a range of from 10 mmHg through 15 mmHg for 5 hours to thereby obtain a reaction product, the reaction container was added with 11 parts of trimellitic anhydride, followed by reacting under normal pressure at 180° C. for 3 hours to thereby obtain [Binder resin B-1].

### Synthetic Example B-2

### Synthesis of Binder Resin B-2

[Binder resin B-2] was obtained in the same manner as in Synthetic Example B-1, except that the molar ratio of isophthalic acid to adipic acid was changed from 70/30 to 50/50.

### Synthetic Example B-3

### Synthesis of Binder Resin B-3

[Binder resin B-3] was obtained in the same manner as in Synthetic Example A-1, except that the amount of styrene was changed from 80 parts by mass to 95 parts by mass, and the amount of butyl acrylate was changed from 20 parts by mass to 17 parts by mass.

### Synthetic Example C-1

### Synthesis of Binder Resin C-1

A reaction vessel equipped with a cooling tube, a stirrer, and a nitrogen inlet tube was charged with monomer components, i.e., sebacic acid, adipic acid, and 1,4-butanediol in a molar ratio of 40/9/51 (sebacic acid/adipic acid/1,4-butanediol). To the reaction vessel, was added 0.25 parts of titanium dihydroxy bis(triethanol aminate) as a condensation catalyst relative to 100 parts of the monomer components, followed by reacting under a nitrogen stream at 180° C. for 4 hours with generated water being distilled off, then reacting under a nitrogen stream for 3 hours while gradually heating to 225° C. with generated water and 1,4-butanediol being distilled off, and further reacting under reduced pressure of a range of from 5 mmHg through 20 mmHg until the weight average molecular weight (Mw) reached about 1,200, to thereby obtain [Binder resin C-1′].

Then, 218 parts of the resultant [Binder resin C-1′] was transferred into a reaction vessel equipped with a cooling tube, a stirrer, and a nitrogen inlet tube. To the reaction vessel, were added 250 parts of ethyl acetate, 40 parts of hexamethylene diisocyanate (HDI), and 25 parts of maleic anhydride, followed by reacting under a nitrogen stream at 80° C. for 5 hours. Then, ethyl acetate was distilled off under reduced pressure, to thereby obtain [Binder resin C-1].

### Synthetic Example C-2

### Synthesis of Binder Resin C-2

A reaction vessel equipped with a cooling tube, a stirrer, and a nitrogen inlet tube was charged with monomer components, i.e., fumaric acid and 1,6-hexanediol in a molar ratio of 50/50. To the reaction vessel, was added 0.25 parts of titanium dihydroxy bis(triethanol aminate) as a condensation catalyst relative to 100 parts of the monomer components, followed by reacting under a nitrogen stream at 180° C. for 4 hours with generated water being distilled off, then reacting under a nitrogen stream for 3 hours while gradually heating to 225° C. with generated water being distilled off, and further reacting under reduced pressure of a range of from 5 mmHg through 20 mmHg until the weight average molecular weight (Mw) reached about 8,000, to thereby obtain [Binder resin C-2′].

Then, 218 parts of the resultant [Binder resin C-2′] was transferred into a reaction vessel equipped with a cooling tube, a stirrer, and a nitrogen inlet tube. To the reaction vessel, were added 250 parts of ethyl acetate, 40 parts of hexamethylene diisocyanate (HDI), and 25 parts of maleic anhydride, followed by reacting under a nitrogen stream at 80° C. for 5 hours. Then, ethyl acetate was distilled off under reduced pressure, to thereby obtain [Binder resin C-2].

### Synthetic Example C-3

### Synthesis of Binder Resin C-3

A reaction vessel equipped with a cooling tube, a stirrer, and a nitrogen inlet tube was charged with monomer components, i.e., 1,10-dodecanedioic acid and 1,9-nonanediol in a molar ratio of 50/50. To the reaction vessel, was added 0.25 parts of titanium dihydroxy bis(triethanol aminate) as a condensation catalyst relative to 100 parts of the monomer components, followed by reacting under a nitrogen stream at 180° C. for 4 hours with generated water being distilled off, then reacting under a nitrogen stream for 3 hours while gradually heating to 225° C. with generated water being distilled off, and further reacting under reduced pressure of a range of from 5 mmHg through 20 mmHg until the weight average molecular weight (Mw) reached about 25,000, to thereby obtain [Binder resin C-3′].

Then, 218 parts of the resultant [Binder resin C-3′] was transferred into a reaction vessel equipped with a cooling tube, a stirrer, and a nitrogen inlet tube. To the reaction vessel, were added 250 parts of ethyl acetate, 40 parts of hexamethylene diisocyanate (HDI), and 25 parts of maleic anhydride, followed by reacting under a nitrogen stream at 80° C. for 5 hours. Then, ethyl acetate was distilled off under reduced pressure, to thereby obtain [Binder resin C-3].

### Synthetic Example C-4

### Synthesis of Binder resin C-4

Crystalline polylactic acid “N-3000” (manufactured by Nature Works LLC) was placed into a tray (35 cm×25 cm), which was left to stand under an environment of a temperature of 80° C. and a humidity of 95% for 48 hours, to thereby obtain [Binder resin C-4].

### Example 1

### Preparation of Toner

(Composition of raw materials)

| | | |
|---|---|---|
| Binder resin 1: [Binder resin A-1] | 85 | parts |
| Binder resin 2: [Binder resin C-3] | 9 | parts |
| Colorant: [Masterbatch 1] | 7 | parts |
| Charging control agent: BONTRON E-84 | 1 | part |
| (manufactured by ORIENT CHEMICAL | | |
| INDUSTRIES CO., LTD.) | | |
| Wax: carnauba wax (WA-05, manufactured | 6 | parts |
| by CERARICA NODA Co., Ltd.) | | |

The above described raw materials of toner powder were mixed well by a super mixer (SMV-200, manufactured by KAWATA MFG CO., Ltd.) to thereby obtain a toner-powder raw-material mixture. The toner-powder raw-material mixture was supplied to a raw material supplying hopper of Buss co-kneader (TCS-100, manufactured by Buss Co., Ltd.) to knead at a supply rate of 120 kg/h. The resultant kneaded product was roll-cooled on a double belt cooler, coarsely pulverized in a hammer mill, finely pulverized in a jet-stream pulverizer (I-20 jet mill, manufactured by Nippon Pneumatic Mfg. Co., Ltd.), and then finely classified by a wind-driven classifier (DS-20•DS-10 classifier, manufactured by Nippon Pneumatic Mfg. Co., Ltd.), to thereby produce [Toner base particles 1].

### —Mixing—

To the [Toner base particles 1], was added hydrophobic silica (HDK-2000, manufactured by Wacker Chemie AG) in an amount of 1.5 parts relative to 100 parts of the [Toner base particles 1], followed by mixing with 20 L HENSCHEL MIXER (manufactured by NIPPON COKE & ENGINEERING COMPANY, LIMITED) at a circumferential velocity of 33 m/s for 5 min and sieving through a 500 mesh sieve to thereby obtain [Toner 1].

### Example 2

[Toner 2] was produced in the same manner as in Example 1, except that the binder resin 1 was changed from [Binder resin A-1] to [Binder resin A-2], and the binder resin 2 was changed from [Binder resin C-3] to [Binder resin C-1].

### Example 3

[Toner 3] was produced in the same manner as in Example 2, except that the binder resin 1 was changed from [Binder resin A-2] to [Binder resin A-3].

### Example 4

[Toner 4] was produced in the same manner as in Example 2, except that the binder resin 1 was changed from [Binder resin A-2] to [Binder resin A-4].

### Example 5

[Toner 5] was produced in the same manner as in Example 2, except that the binder resin 1 was changed from [Binder resin A-2] to [Binder resin A-5].

### Example 6

[Toner 6] was produced in the same manner as in Example 2, except that the binder resin 1 was changed from [Binder resin A-2] to [Binder resin A-6].

### Example 7

[Toner 7] was produced in the same manner as in Example 2, except that the binder resin 1 was changed from [Binder resin A-2] to [Binder resin A-7].

### Example 8

[Toner 8] was produced in the same manner as in Example 2, except that the binder resin 2 was changed from [Binder resin C-1] to [Binder resin C-2].

### Example 9

[Toner 9] was produced in the same manner as in Example 2, except that the binder resin 2 was changed from [Binder resin C-1] to [Binder resin C-3].

### Comparative Example 1

[Toner 10] was produced in the same manner as in Example 2, except that the binder resin 1 was changed from [Binder resin A-2] to [Binder resin B-1].

### Comparative Example 2

[Toner 11] was produced in the same manner as in Example 2, except that the binder resin 1 was changed from [Binder resin A-2] to [Binder resin B-2].

### Comparative Example 3

[Toner 12] was produced in the same manner as in Example 1, except that the binder resin 1 was changed from [Binder resin A-1] to [Binder resin B-3].

### Comparative Example 4

[Toner 13] was produced in the same manner as in Example 2, except that amounts of the binder resin 1 and the binder resin 2 were changed to 94 parts and 0 parts.

### Comparative Example 5

[Toner 14] was produced in the same manner as in Example 2, except that the binder resin 2 was changed from [Binder resin C-] to [Binder resin C-4].

### (Measurement)

Toners of the above described Examples and Comparative Examples were subjected to the following measurements.

### <DSC Measurement>

A DSC measurement was performed with DSC-6220R (manufactured by Seiko Instruments Inc.). A sample was heated from room temperature to 150° C. at a temperature rising rate of 10° C./min (first temperature rising); left to stand at 150° C. for 10 min; cooled to room temperature; left to stand at room temperature for 10 min; and then heated again to 150° C. at a temperature rising rate of 10° C./min (second temperature rising). In the resultant DSC curve, the glass transition temperature Tg (° C.) was determined from the base line at a temperature equal to or lower than the glass transition temperature and a curved line portion at a height which is at the same distance both from the base line at a temperature equal to or lower than the glass transition temperature and from the base line at a temperature equal to or higher than the glass transition temperature.

### <GPC Measurement>

A GPC measurement was performed as follows.

Gel permeation chromatography (GPC) measuring device: GPC-8220GPC (manufactured by Tosoh Corporation)

Column: TSK-GEL SUPER HZ2000, TSK-GEL SUPER HZ2500, and TSK-GEL SUPER HZ3000

Temperature: 40° C.

Solvent: tetrahydrofuran (THF)

Flow rate: 0.35 mL/min

Sample: THF sample solution having a concentration adjusted to 0.15% by mass

Pretreatment of sample: a toner was dissolved in THF (containing a stabilizer, manufactured by Wako Pure Chemical Industries, Ltd.) at 0.15% by mass, followed by filtering through a 0.45 μm filter. The resultant filtrate was used as the sample.

The measurement was performed by injecting a range of from 10 μL through 200 μL of the THF sample solution. As for the measurement of the sample, a molecular weight of the sample was calculated from the relationship between the number of counts and the logarithmic value of the calibration curve prepared from several monodispersed polystyrene standard samples.

As for the polystyrene standard sample for preparing the calibration curve, for example, polystyrene standard samples having molecular weights of 6×10², 2.1×10³, 4×10³, 1.75×10⁴, 5.1×10⁴, 1.1×10⁵, 3.9×10⁵, 8.6×10⁵, 2×10⁶ and 4.48×10⁶ (manufactured by Pressure Chemical Company or Tosoh Corporation) were used. As for a detector, a refractive index (RI) detector was used.

For the GPC measurement results, a molecular weight distribution curve was plotted by taking an intensity as a vertical axis and a molecular weight as a horizontal axis, and peak intensities throughout the molecular weight distribution curve were corrected assuming the maximum peak value in molecular weights of 20,000 or less is 100. Next, a difference between the maximum value and the minimum value among peak intensities in the range of the Molecular weight M+300 for molecular weights in a range of from 300 through 5,000 was determined. Notably, the difference between GPC peak intensities described in the following Table 1-1 is the maximum value used for determining the difference.

### <Preparative GPC>

A preparative GPC was performed based on the resultant molecular weight distribution as follows.

Device: pump LC-6A, fraction collector FRC-10A, and RI detector RID-10A (manufactured by SHIMADZU CORPORATION)

Column: SHODEX K2002×2+SHODEX K2003 (diameter: 20 mm, length: 300 mm)

Mobile phase: chloroform

Flow rate: 2.8 mL/min

Column oven: 45° C.

Results are present in the following Table 1-1.

TABLE 1-1

| | | | | GPC measurement and preparative GPC | | | |
|---|---|---|---|---|---|---|---|
| | | | | Difference | Presence of derivative | Specific derivative | |
| | | | | of GPC | of compound having Mw | components of | |
| | | | | peak | of 210 or less and acid | components extracted | |
| | Toner | Binder resin | | intensity | functional group | by preparative GPC | |
| Ex. 1 | Toner 1 | A-1 | C-3 | 5 | No | Styrene | — |
| Ex. 2 | Toner 2 | A-2 | C-1 | 3 | Yes | Isophthalic | Adipic |
| | | | | | | acid | acid |
| Ex. 3 | Toner 3 | A-3 | C-1 | 5 | Yes | Isophthalic | Adipic |
| | | | | | | acid | acid |
| Ex. 4 | Toner 4 | A-4 | C-1 | 3 | Yes | Isophthalic | — |
| | | | | | | acid | |
| Ex. 5 | Toner 5 | A-5 | C-1 | 26 | Yes | Isophthalic | Adipic |
| | | | | | | acid | acid |
| Ex. 6 | Toner 6 | A-6 | C-1 | 4 | Yes | Isophthalic | Terephthalic |
| | | | | | | acid | acid |
| Ex. 7 | Toner 7 | A-7 | C-1 | 2 | Yes | Terephthalic | Fumaric |
| | | | | | | acid | acid |
| Ex. 8 | Toner 8 | A-2 | C-2 | 3 | Yes | Isophthalic | Adipic |
| | | | | | | acid | acid |
| Ex. 9 | Toner 9 | A-2 | C-3 | 5 | Yes | Isophthalic | Adipic |
| | | | | | | acid | acid |
| Comp. | Toner 10 | B-1 | C-1 | 45 | Yes | Isophthalic | Adipic |
| Ex. 1 | | | | | | acid | acid |
| Comp. | Toner 11 | B-2 | C-1 | 26 | Yes | Isophthalic | Adipic |
| Ex. 2 | | | | | | acid | acid |
| Comp. | Toner 12 | B-3 | C-3 | 33 | No | Styrene | — |
| Ex. 3 | | | | | | | |
| Comp. | Toner 13 | A-2 | — | 3 | Yes | Isophthalic | Adipic |
| Ex. 4 | | | | | | acid | acid |
| Comp. | Toner 14 | A-2 | C-4 | 3 | Yes | Isophthalic | Adipic |
| Ex. 5 | | | | | | acid | acid |

TABLE 1-2

| | | | DSC measurement | |
|---|---|---|---|---|
| | | | | Presence or |
| | | | | absence |
| | | | | of Tg at second |
| | | | Tg at first | temperature |
| | | | temperature | rising in range |
| | Toner composition | | rising | of X° C. to X |
| | Polyester component | | (° C.) | −20° C. |
| Ex. 1 | Dodecane | 1,9-Nonanediol | 60 | Absence |
| | dicarboxylic | | | |
| | acid | | | |
| Ex. 2 | Sebacic acid | 1,4-Butanediol | 52 | Absence |
| Ex. 3 | Sebacic acid | 1,4-Butanediol | 40 | Absence |
| Ex. 4 | Sebacic acid | 1,4-Butanediol | 70 | Absence |
| Ex. 5 | Sebacic acid | 1,4-Butanediol | 52 | Absence |
| Ex. 6 | Sebacic acid | 1,4-Butanediol | 52 | Absence |
| Ex. 7 | Sebacic acid | 1,4-Butanediol | 57 | Absence |
| Ex. 8 | Fumaric acid | 1,6-Hexanediol | 53 | Absence |
| Ex. 9 | Dodecane | 1,9-Nonanediol | 55 | Absence |
| | dicarboxylic | | | |
| | acid | | | |
| Comp. | Sebacic acid | 1,4 -Butanediol | 52 | Absence |
| Ex. 1 | | | | |
| Comp. | Sebacic acid | 1,4-Butanediol | 38 | Absence |
| Ex. 2 | | | | |
| Comp. | Dodecane | 1,9-Nonanediol | 62 | Absence |
| Ex. 3 | dicarboxylic | | | |
| | acid | | | |
| Comp. | None | None | 53 | Presence |
| Ex. 4 | | | | |
| Comp. | None | None | 68 | Presence |
| Ex. 5 | | | | |

### (Evaluation Method and Evaluation Result)

The resultant toners were subjected to the following evaluations. Results are presented in Table 2.

### <Low Temperature Fixing Property>

An image forming apparatus (“IPSIO COLOR 8100”; manufactured by Ricoh Company, Ltd.), which had been modified and tuned to an oil-less fixing system, was used for evaluation. Sheets of thick paper (“paper for copying and printing <135>”; manufactured by RICOH JAPAN Corp.) were set to the apparatus. The apparatus was adjusted to develop a solid image with a toner at 1.0±0.1 mg/cm². A fixing roll temperature at which a residual rate of image density after the resultant fixed image was rubbed with a pad was 70% or higher was determined as a fixing lower limit temperature.

### [Evaluation Criteria]

A: Fixing lower limit temperature was lower than 110° C.

B: Fixing lower limit temperature was 110° C. or higher but lower than 125° C.

C: Fixing lower limit temperature was 125° C. or higher but lower than 150° C.

D: Fixing lower limit temperature was 150° C. or higher.

### <Storage Stability (Heat Resistant Storability)>

The toners were stored at 50° C. for 8 hours, followed by sieving through a 42 mesh sieve for 2 min. A residual rate of the toner remaining on the sieve was determined as an index of the heat resistant storability.

### [Evaluation Criteria]

The heat resistant storability was evaluated in 4 grades according to the following criteria. “A” and “B” represent a satisfactory level, “C” represents a practically acceptable level despite of its slightly poor storability, and “D” represents a problematic level as a high-quality toner.

A: lower than 5%

B: 5% or higher but lower than 10%

C: 10% or higher but lower than 25%

D: 25% or higher

### <Charging Stability>

A durability was tested using each of developing agents. A character and image pattern at an image area rate of 12% was continuously output on 100,000 sheets to evaluate a change of a charging amount before and after the output. A small amount of the developing agent was taken from a sleeve, and the change of the charge amount was determined by the blowoff method and evaluated according to the following evaluation criteria.

### [Evaluation Criteria]

A: Change of charging amount is less than 2.0 μc/g.

B: Change of charging amount is 2.0 μc/g or higher but lower than 5.0 μc/g.

C: Change of charging amount is 5.0 μc/g or higher but lower than 8.0 μc/g.

D: Change of charging amount is 8.0 μc/g or higher.

Results are presented in the following Table 2.

### <Overall Evaluation>

Evaluation results of the low temperature fixing property, the storage stability, and the charging stability of the toner were expressed by points, and the total point in the low temperature fixing property, the storage stability, and the charging stability of the toner was regard as overall evaluation. Specifically, “D” means “0 points”, “C” means “1 point”, “B” means “2 points”, and “A” means “3 points” in each item. Overall evaluation was conducted based on the following evaluation criteria.

### [Evaluation Criteria]

A: The total point was 8 points or more, and each item is not evaluated as 0 point (D).

B: The total point was a range of from 6 through 7 points, and each item is not evaluated as 0 point (D).

C: The total point was 5 points or less, and each item is not evaluated as 0 point (D).

D: One or more items were evaluated as 0 point (D) regardless of the total points.

In the overall evaluation, the toner evaluated as “C” can be practically used, the toner evaluated as “B” is superior to the conventional toners, and the toner evaluated as “A” is considerably excellent as a guide.

TABLE 2

| | | Evaluation | | | |
|---|---|---|---|---|---|
| | | Low temperature | Storage | Charging | Overall |
| | Toner | fixing property | stability | stability | evaluation |
| Ex. 1 | Toner 1 | C | B | B | C |
| Ex. 2 | Toner 2 | B | A | A | A |
| Ex. 3 | Toner 3 | A | B | A | A |
| Ex. 4 | Toner 4 | C | A | B | B |
| Ex. 5 | Toner 5 | A | C | B | B |
| Ex. 6 | Toner 6 | B | A | B | B |
| Ex. 7 | Toner 7 | C | A | A | B |
| Ex. 8 | Toner 8 | B | A | A | A |
| Ex. 9 | Toner 9 | C | A | A | B |
| Comp. | Toner 10 | B | D | C | D |
| Ex. 1 | | | | | |
| Comp. | Toner 11 | B | D | D | D |
| Ex. 2 | | | | | |
| Comp. | Toner 12 | C | D | C | D |
| Ex. 3 | | | | | |
| Comp. | Toner 13 | D | B | D | D |
| Ex. 4 | | | | | |
| Comp. | Toner 14 | D | B | C | D |
| Ex. 5 | | | | | |

As clearly can be seen from evaluation results in Table 2, the toners of Examples 1 to 9 are excellent in all of the low temperature fixing property, the heat resistant storability, and the charging stability. Of these, the toners of Examples 2, 3, and 8 are especially excellent. In contrast, the toner of Comparative Examples 1 to 5 are practically problematic as a high-quality toner in all of the low temperature fixing property, the heat resistant storability, and the charging stability.

What is claimed is:

1. A toner comprising
a binder resin,
wherein the toner, as measured by differential scanning calorimetry (DSC), has a glass transition temperature in a range of from 40° C. through 70° C. at a first temperature rising and has no glass transition temperature in a range of from X° C. through X−20° C. at a second temperature rising where X° C. denotes the glass transition temperature at the first temperature rising,
wherein the toner has a difference of 30 or less between a maximum value and a minimum value among peak intensities in a range of Molecular weight M±300 where Molecular weight M is a molecular weight selected from a range of from 300 through 5,000 in a molecular weight distribution of tetrahydrofuran (THF)-soluble components in the toner as measured by gel permeation chromatography (GPC), and
wherein the peak intensities are defined as relative values assuming a maximum peak value in molecular weights of 20,000 or less is 100, in a molecular weight distribution curve taking an intensity as a vertical axis and a molecular weight as a horizontal axis as measured by GPC.

2. The toner according to claim 1,
wherein, when fractionating, through preparative GPC, components having the difference of 30 or less between a maximum value and a minimum value among peak intensities in a range of Molecular weight M±300 where Molecular weight M is a molecular weight selected from a range of 300 to 5,000, any of the components that have been fractionated comprises a material comprising Monomer A, and wherein the Monomer A is a monomer having a molecular weight of 210 or less and comprising an acid functional group.

3. The toner according to claim 2,
wherein the Monomer A is a dicarboxylic acid selected from an aromatic dicarboxylic acid and an aliphatic dicarboxylic acid, the aromatic dicarboxylic acid being selected from the group consisting of isophthalic acid, terephthalic acid, and phthalic acid, and the aliphatic dicarboxylic acid being selected from the group consisting of succinic acid, glutaric acid, adipic acid, and sebacic acid.

4. The toner according to claim 1,
wherein the binder resin comprises a polyester resin made of an aliphatic diol and an aliphatic dicarboxylic acid, the aliphatic diol being one or more selected from the group consisting of 1,4-butanediol, 1,6-hexanediol, and 1,9-nonanediol, and the aliphatic dicarboxylic acid being one or more selected from the group consisting of fumaric acid, sebacic acid, and dodecane dicarboxylic acid.

5. The toner according to claim 2,
wherein the binder resin comprises a polyester resin made of an aliphatic diol and an aliphatic dicarboxylic acid, the aliphatic diol being one or more selected from the group consisting of 1,4-butanediol, 1,6-hexanediol, and 1,9-nonanediol, and the aliphatic dicarboxylic acid being one or more selected from the group consisting of fumaric acid, sebacic acid, and dodecane dicarboxylic acid.

6. The toner according to claim 3,
wherein the binder resin comprises a polyester resin made of an aliphatic diol and an aliphatic dicarboxylic acid, the aliphatic diol being one or more selected from the group consisting of 1,4-butanediol, 1,6-hexanediol, and 1,9-nonanediol, and the aliphatic dicarboxylic acid being one or more selected from the group consisting of fumaric acid, sebacic acid, and dodecane dicarboxylic acid.

7. A toner stored unit comprising
a toner,
wherein the toner comprises a binder resin,
wherein the toner, as measured by differential scanning calorimetry (DSC), has a glass transition temperature in a range of from 40° C. through 70° C. at a first temperature rising and has no glass transition temperature in a range of from X° C. through X−20° C. at a second temperature rising where X° C. denotes the glass transition temperature at the first temperature rising,
wherein the toner has a difference of 30 or less between a maximum value and a minimum value among peak intensities in a range of Molecular weight M±300 where Molecular weight M is a molecular weight selected from a range of from 300 through 5,000 in a molecular weight distribution of tetrahydrofuran (THF)-soluble components in the toner as measured by gel permeation chromatography (GPC), and
wherein the peak intensities are defined as relative values assuming a maximum peak value in molecular weights of 20,000 or less is 100, in a molecular weight distribution curve taking an intensity as a vertical axis and a molecular weight as a horizontal axis as measured by GPC.

8. The toner stored unit according to claim 7,
wherein, when fractionating, through preparative GPC, components having the difference of 30 or less between a maximum value and a minimum value among peak intensities in a range of Molecular weight M±300 where Molecular weight M is a molecular weight selected from a range of from 300 through 5,000, any of the components that have been fractionated comprises a material comprising Monomer A, and wherein the Monomer A is a monomer having a molecular weight of 210 or less and comprising an acid functional group.

9. The toner stored unit according to claim 8,
wherein the Monomer A is a dicarboxylic acid selected from an aromatic dicarboxylic acid and an aliphatic dicarboxylic acid, the aromatic dicarboxylic acid being selected from the group consisting of isophthalic acid, terephthalic acid, and phthalic acid, and the aliphatic dicarboxylic acid being selected from the group consisting of succinic acid, glutaric acid, adipic acid, and sebacic acid.

10. The toner stored unit according to claim 7,
wherein the binder resin comprises a polyester resin made of an aliphatic diol and an aliphatic dicarboxylic acid, the aliphatic diol being one or more selected from the group consisting of 1,4-butanediol, 1,6-hexanediol, and 1,9-nonanediol, and the aliphatic dicarboxylic acid being one or more selected from the group consisting of fumaric acid, sebacic acid, and dodecane dicarboxylic acid.

11. The toner stored unit according to claim 8,
wherein the binder resin comprises a polyester resin made of an aliphatic diol and an aliphatic dicarboxylic acid, the aliphatic diol being one or more selected from the group consisting of 1,4-butanediol, 1,6-hexanediol, and 1,9-nonanediol, and the aliphatic dicarboxylic acid being one or more selected from the group consisting of fumaric acid, sebacic acid, and dodecane dicarboxylic acid.

12. The toner stored unit according to claim 9,
wherein the binder resin comprises a polyester resin made of an aliphatic diol and an aliphatic dicarboxylic acid, the aliphatic diol being one or more selected from the group consisting of 1,4-butanediol, 1,6-hexanediol, and 1,9-nonanediol, and the aliphatic dicarboxylic acid being one or more selected from the group consisting of fumaric acid, sebacic acid, and dodecane dicarboxylic acid.

13. An image forming apparatus comprising:
an electrostatic latent image bearer;
an electrostatic latent image forming unit configured to form an electrostatic latent image on the electrostatic latent image bearer;
a developing unit containing a toner and configured to develop the electrostatic latent image with the toner to form a visible image;
a transfer unit configured to transfer the visible image onto a recording medium to form a transferred image; and
a fixing unit configured to fix the transferred image on the recording medium;
wherein the toner comprises a binder resin,
wherein the toner, as measured by differential scanning calorimetry (DSC), has a glass transition temperature in a range of from 40° C. through 70° C. at a first temperature rising and has no glass transition temperature in a range of from X° C. through X−20° C. at a second temperature rising where X° C. denotes the glass transition temperature at the first temperature rising,
wherein the toner has a difference of 30 or less between a maximum value and a minimum value among peak intensities in a range of Molecular weight M±300 where Molecular weight M is a molecular weight selected from a range of from 300 through 5,000 in a molecular weight distribution of tetrahydrofuran (THF)-soluble components in the toner as measured by gel permeation chromatography (GPC), and
wherein the peak intensities are defined as relative values assuming a maximum peak value in molecular weights of 20,000 or less is 100, in a molecular weight distribution curve taking an intensity as a vertical axis and a molecular weight as a horizontal axis as measured by GPC.

14. The image forming apparatus according to claim 13,
wherein, when fractionating, through preparative GPC, components having the difference of 30 or less between a maximum value and a minimum value among peak intensities in a range of Molecular weight M±300 where Molecular weight M is a molecular weight selected from a range of from 300 through 5,000, any of the components that have been fractionated comprises a material comprising Monomer A, and wherein the Monomer A is a monomer having a molecular weight of 210 or less and comprising an acid functional group.

15. The image forming apparatus according to claim 14,
wherein the Monomer A is a dicarboxylic acid selected from an aromatic dicarboxylic acid and an aliphatic dicarboxylic acid, the aromatic dicarboxylic acid being selected from the group consisting of isophthalic acid, terephthalic acid, and phthalic acid, and the aliphatic dicarboxylic acid being selected from the group consisting of succinic acid, glutaric acid, adipic acid, and sebacic acid.

16. The image forming apparatus according to claim 13,
wherein the binder resin comprises a polyester resin made of an aliphatic diol and an aliphatic dicarboxylic acid, the aliphatic diol being one or more selected from the group consisting of 1,4-butanediol, 1,6-hexanediol, and 1,9-nonanediol, and the aliphatic dicarboxylic acid being one or more selected from the group consisting of fumaric acid, sebacic acid, and dodecane dicarboxylic acid.

17. The image forming apparatus according to claim 14,
wherein the binder resin comprises a polyester resin made of an aliphatic diol and an aliphatic dicarboxylic acid, the aliphatic diol being one or more selected from the group consisting of 1,4-butanediol, 1,6-hexanediol, and 1,9-nonanediol, and the aliphatic dicarboxylic acid being one or more selected from the group consisting of fumaric acid, sebacic acid, and dodecane dicarboxylic acid.

18. The image forming apparatus according to claim 15,
wherein the binder resin comprises a polyester resin made of an aliphatic diol and an aliphatic dicarboxylic acid, the aliphatic diol being one or more selected from the group consisting of 1,4-butanediol, 1,6-hexanediol, and 1,9-nonanediol, and the aliphatic dicarboxylic acid being one or more selected from the group consisting of fumaric acid, sebacic acid, and dodecane dicarboxylic acid.
